(19) United States
(12) Patent Application Publication
(10) Pub. No.: US 2020/0290882 A1
(43) Pub. Date: Sep. 17, 2020

(54) HYDRATED CARBON MATERIAL POWDER AND USE OF IT FOR PREPARATION OF AN ELECTRODE FOR AN ELECTRICAL STORAGE DEVICE

(71) Applicant: EnerG2 Technologies, Inc., Seattle, WA (US)

(72) Inventors: Sarah Fredrick, Denver, CO (US); Virginia Katherine Alspaugh, Seattle, WA (US); Farshid Afkhami, Lake Stevens, WA (US); Chad Goodwin, Seattle, WA (US); Adam Strong, Lake Forest Park, WA (US); Aaron M. Feaver, Seattle, WA (US); Philip Hamilton, Seattle, WA (US)

(21) Appl. No.: 16/649,030

(22) PCT Filed: Sep. 20, 2018
(86) PCT No.: PCT/US18/52039

§ 371 Date: Mar. 19, 2020

Related U.S. Application Data
(60) Provisional application No. 62/561,081, filed on Sep. 20, 2017.

(51) Int. Cl. C01B 32/30

(52) U.S. Cl. CPC C01B 32/30; C01P 2006/14; C01P 2006/82; C01P 2006/16; C01P 2006/12

(57) ABSTRACT

The present application is generally directed to hydrated carbon material powder comprising carbon material and water and devices containing the same. The hydrated carbon material powder finds utility in any number of devices, for example, in electric double layer capacitance devices and batteries. Methods for making and use of the hydrated carbon material powder are also disclosed.

### BACKGROUND

### Technical Field

Embodiments of the present invention generally relate to hydrated carbon material powder as well as devices containing hydrated carbon material powder and methods related to the same.

### Description of the Related Art

Devices containing activated carbon, silicon, sulfur, lithium, and combinations thereof are ubiquitous throughout the electrical industry. Of these, activated carbon particles find particular use in a number of devices because the high surface area, conductivity and porosity of activated carbon allows for the design of electrical devices having higher energy density than devices employing other materials.

Electric double-layer capacitors (EDLCs) are an example of devices that contain activated carbon particles. EDLCs often have electrodes prepared from an activated carbon material and a suitable electrolyte, and have an extremely high energy density compared to more common capacitors. Typical uses for EDLCs include energy storage and distribution in devices requiring short bursts of power for data transmissions, or peak-power functions such as wireless modems, mobile phones, digital cameras and other hand-held electronic devices. EDLCs are also commonly used in electric vehicles such as electric cars, trains, buses and the like.

Batteries are another common energy storage and distribution device which often contain activated carbon particles (e.g., as anode material, current collector, or conductivity enhancer). Examples of carbon-containing batteries include lithium air batteries, which use porous carbon as the current collector for the air electrode, and lead acid batteries which often include carbon additives in either the anode or cathode. Batteries are employed in any number of electronic devices requiring low current density electrical power (as compared to an EDLC's high current density).

Use of carbon particle based-material often requires the activated carbon material to be hydrated or “wetted.” Inadequately hydrated carbon materials can leach water from surrounding material, which can lead to damaged components and/or device failure. For example, when improperly hydrated carbon material is used in lead acid paste, leaching causes dry spots, which can damage the integrity of the final cured and formed plate.

The hydration process (e.g., by forming an aqueous slurry) generally involves soaking carbon materials in excessive amounts of water over the course of several hours. The carbon materials must be monitored and continuously mixed to ensure uniform and complete hydration, which is resource intensive both in terms of time, effort and equipment. Saving time by manufacturing and shipping carbon material as a dispersion in water (i.e., pre-soaked) is impractical due to high shipping costs and handling difficulty. Handling of dry carbon material also has drawbacks because processing dry material can release potentially harmful particulate, a process known as “dusting.”

Accordingly, a need exists in the art for hydrated carbon material powder that can be handled easily during manufacturing processes, as well as for methods of making the same and devices containing the same. Embodiments of the present invention fulfill these needs and provide further related advantages.

### BRIEF SUMMARY

In general terms, embodiments of the present invention are directed to hydrated carbon material powder comprising carbon material and water. Specifically, one embodiment provides a hydrated carbon material powder comprising a porous carbon material having a pore volume and a volume of water greater than the pore volume.

Another embodiment provides an isolated solid composition comprising a porous carbon material and water, wherein the composition comprises a volume of water greater than a total pore volume of the porous carbon material.

Yet another embodiment affords a method for preparing a hydrated carbon material powder, the method comprising:

contacting a porous carbon material having a pore volume with a first volume of water greater than the pore volume, thereby substantially filling the pore volume with water;

removing a portion of the first volume of water; and

isolating the hydrated carbon material in powder form, wherein the hydrated carbon material powder comprises a second volume of water greater than the pore volume.

Another embodiment provides a method for preparing a negative active material for a lead acid battery, the method comprising admixing the hydrated carbon material powder according to embodiments disclosed herein, or the isolated solid composition according to embodiments disclosed herein, with lead, water and sulfuric acid, thereby forming a paste.

An additional embodiment affords use of the hydrated carbon material powder as disclosed herein, or the isolated solid composition according to embodiments disclosed herein, for preparation of an electrode for an electrical storage device, for example, an EDLC.

These and other aspects will be apparent upon reference to the following detailed description.

### BRIEF DESCRIPTION OF THE DRAWINGS

In the figures, identical reference numbers identify similar elements. The sizes and relative positions of elements in the figures are not necessarily drawn to scale and some of these elements are enlarged and positioned to improve figure legibility. Further, the particular shapes of the elements as drawn are not intended to convey any information regarding the actual shape of the particular elements, and have been solely selected for ease of recognition in the figures.

FIGS. 1A and 1B show there is no measurable difference in capacity for negative active material prepared with hydrated and non-hydrated carbon material powder.

FIG. 2 shows Motive Recharge Time for NAM 1 and NAM 2 with NAM 2 showing a greatly reduced average charge time (a 43% reduction).

FIG. 3 depicts the improvement in average cycles until the 1^{st} failure for cells including NAM 1 and NAM 2 with NAM 2 showing a 33% improvement in the number of cycles until failure.

FIGS. 4A and 4B illustrate how Slurry 1 prepared with dry Carbon 3 does not remain in suspension during processing while Slurry 2 prepared with dry Carbon 3 remains in suspension.

### DETAILED DESCRIPTION

In the following description, certain specific details are set forth in order to provide a thorough understanding of various embodiments. However, one skilled in the art will understand that embodiments of the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In the present description, any concentration range, percentage range, ratio range, or integer range is to be understood to include the value of any integer within the recited range and, when appropriate, fractions thereof (such as one tenth and one hundredth of an integer), unless otherwise indicated. Also, any number range recited herein relating to any physical feature (e.g., subunits, size, etc.) are to be understood to include any integer within the recited range, unless otherwise indicated. As used herein, the terms “about” and “approximately” mean±20%, ±10%, ±5% or ±1% of the indicated range, value, or structure, unless otherwise indicated.

As used herein, and unless the context dictates otherwise, the following terms have the meanings as specified below.

“Carbon material” refers to a material or substance comprised substantially of carbon. Examples of carbon materials include, but are not limited to, activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like.

“Amorphous” refers to a material, for example an amorphous carbon material, whose constituent atoms, molecules, or ions are arranged randomly without a regular repeating pattern. Amorphous materials may have some localized crystallinity (i.e., regularity) but lack long-range order of the positions of the atoms. Pyrolyzed and/or activated carbon materials are generally amorphous.

“Crystalline” refers to a material whose constituent atoms, molecules, or ions are arranged in an orderly repeating pattern. Examples of crystalline carbon materials include, but are not limited to, diamond and graphene.

“Powder” refers to a composition that contains finely dispersed solid particles that are relatively free flowing and is not dissolved or suspended in a solvent.

“Synthetic” refers to a substance which has been prepared by chemical means rather than from a natural source. For example, a synthetic carbon material is one which is synthesized from precursor materials and is not isolated from natural sources.

“Impurity” or “impurity element” refers to a foreign substance (e.g., a chemical element) within a material which differs from the chemical composition of the base material. For example, an impurity in a carbon material refers to any element or combination of elements, other than carbon, which is present in the carbon material. Impurity levels are typically expressed in parts per million (ppm).

“PIXE impurity” is any impurity element having an atomic number ranging from 11 to 92 (i.e., from sodium to uranium). The phrases “total PIXE impurity content” and “total PIXE impurity level” both refer to the sum of all PIXE impurities present in a sample, for example, a polymer gel or a carbon material. PIXE impurity concentrations and identities may be determined by proton induced x-ray emission (PIXE).

Purity may also be determined using total x-ray reflection (TXRF). The phrase “total TXRF impurity content” and “total TXRF impurity level” both refer to the sum of all TXRF impurities present in a sample, for example, a polymer gel or a carbon material.

In some embodiments, “ultrapure” refers to a substance having a total PIXE impurity content of less than 0.050%. For example, in some embodiments an “ultrapure carbon material” is a carbon material having a total PIXE impurity content of less than 0.050% (i.e., 500 ppm).

In some embodiments, “ultrapure” refers to a substance having a total TXRF impurity content of less than 0.050%. For example, in some embodiments an “ultrapure carbon material” is a carbon material having a total TXRF impurity content of less than 0.050% (i.e., 500 ppm).

“Ash content” refers to the nonvolatile inorganic matter which remains after subjecting a substance to a high decomposition temperature. Herein, the ash content of a carbon material is calculated from the total PIXE impurity content as measured by proton induced x-ray emission, assuming that nonvolatile elements are completely converted to expected combustion products (i.e., oxides).

“Acid” refers to any substance that is capable of lowering the pH of a solution. Acids include Arrhenius, Bronsted and Lewis acids. A “solid acid” refers to a dried or granular compound that yields an acidic solution when dissolved in a solvent. The term “acidic” means having the properties of an acid.

“Base” refers to any substance that is capable of raising the pH of a solution. Bases include Arrhenius, Bronsted and Lewis bases. A “solid base” refers to a dried or granular compound that yields basic solution when dissolved in a solvent. The term “basic” means having the properties of a base.

“Pyrolyzed dried polymer gel” refers to a dried polymer gel which has been pyrolyzed but not yet activated, while an “activated dried polymer gel” refers to a dried polymer gel which has been activated.

“Cryogel” refers to a dried gel that has been dried by freeze drying.

“Pyrolyzed cryogel” is a cryogel that has been pyrolyzed but not yet activated.

“Activated cryogel” is a cryogel which has been activated to obtain activated carbon material.

“Xerogel” refers to a dried gel that has been dried by air drying, for example, at or below atmospheric pressure.

“Pyrolyzed xerogel” is a xerogel that has been pyrolyzed but not yet activated.

“Activated xerogel” is a xerogel which has been activated to obtain activated carbon material.

“Aerogel” refers to a dried gel that has been dried by supercritical drying, for example, using supercritical carbon dioxide.

“Pyrolyzed aerogel” is an aerogel that has been pyrolyzed but not yet activated.

“Activated aerogel” is an aerogel which has been activated to obtain activated carbon material.

“Pore” refers to an opening or depression in the surface, or a tunnel in a carbon particle, such as for example activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like. A pore can be a single tunnel or connected to other tunnels in a continuous network throughout the structure.

“Pore structure” refers to the layout of the surface of the internal pores within a carbon material, such as an activated carbon material. Components of the pore structure include pore size, pore volume, surface area, density, pore size distribution, and pore length. Generally the pore structure of activated carbon material comprises micropores and mesopores.

“Mesopore” generally refers to pores having a diameter from about 2 nanometers to about 30 nanometers (300 Å) while the term “micropore” refers to pores having a diameter less than about 2 nanometers (20 Å). “Mesoporous” refers to carbon materials wherein greater than 50% of the pore volume in mesopores while “microporous” refers to carbon materials wherein greater than 50% of the pore volume in micropores.

“Pore volume” refers to the volume of the carbon material occupied by pores or empty space per unit of mass of the carbon material (e.g., per gram).

“Surface area” refers to the total specific surface area of a substance measurable by the BET technique. Surface area is typically expressed in units of m²/g. The BET (Brunauer/Emmett/Teller) technique employs an inert gas, for example nitrogen, to measure the amount of gas adsorbed on a material and is commonly used in the art to determine the accessible surface area of materials.

The structural properties of carbon materials may be measured using Nitrogen sorption at 17K, a method known to those of skill in the art. The Micromeretics ASAP 2020 may be used to perform detailed micropore and mesopore analysis. The system produces a nitrogen isotherm starting at a pressure of 10⁻⁷ atm, which enables high resolution pore size distributions in the sub 1 nm range. The software generated reports utilize a Density Functional Theory (DFT) method to calculate properties such as pore size distributions, surface area distributions, total surface area, total pore volume, and pore volume within certain pore size ranges.

“Effective length” refers to the portion of the length of the pore that is of sufficient diameter such that it is available to accept salt ions from the electrolyte.

“Electrode” refers to a conductor through which electricity enters or leaves an object, substance, or region.

“Binder” refers to a material capable of holding individual particles of carbon together such that after mixing a binder and carbon together the resulting mixture can be formed into sheets, pellets, disks or other shapes. Non-exclusive examples of binders include fluoro polymers, such as, for example, PTFE (polytetrafluoroethylene, Teflon), PFA (perfluoroalkoxy polymer resin, also known as Teflon), FEP (fluorinated ethylene propylene, also known as Teflon), ETFE (polyethylenetetrafluoroethylene, sold as Tefzel and Fluon), PVF (polyvinyl fluoride, sold as Tedlar), ECTFE (polyethylenechlorotrifluoroethylene, sold as Halar), PVDF (polyvinylidene fluoride, sold as Kynar), PCTFE (polychlorotrifluoroethylene, sold as Kel-F and CTFE), trifluoroethanol and combinations thereof.

“Inert” refers to a material that is not active in the electrolyte, that is it does not absorb a significant amount of ions or change chemically, e.g., degrade.

“Conductive” refers to the ability of a material to conduct electrons through transmission of loosely held valence electrons.

“Current collector” refers to a part of an electrical energy storage and/or distribution device which provides an electrical connection to facilitate the flow of electricity in to, or out of, the device. Current collectors often comprise metal and/or other conductive materials and may be used as a backing for electrodes to facilitate the flow of electricity to and from the electrode.

“Electrolyte” means a substance containing free ions such that the substance is electrically conductive. Examples of electrolytes include, but are not limited to, solvents such as propylene carbonate, ethylene carbonate, butylene carbonate, dimethyl carbonate, methyl ethyl carbonate, diethyl carbonate, sulfolane, methylsulfolane, acetonitrile or mixtures thereof in combination with solutes such as tetraalkylammonium salts such as TEA TFB (tetraethylammonium tetrafluoroborate), MTEATFB (methyltriethylammonium tetrafluoroborate), EMITFB (1 ethyl-3-methylimidazolium tetrafluoroborate), tetraethylammonium, triethylammonium based salts or mixtures thereof. In some embodiments, the electrolyte can be a water-based acid or water-based base electrolyte such as mild aqueous sulfuric acid or aqueous potassium hydroxide.

1. Hydrated Carbon Material Powder

One embodiment provides a hydrated carbon material powder comprising a porous carbon material having a pore volume and a volume of water greater than the pore volume. It is understood that “powder” refers to finely dispersed solid particles that are relatively free flowing, which are not dissolved or suspended in a solvent or carrier medium (e.g., isolated solid particles).

One specific embodiment provides a hydrated carbon material powder consisting of a porous carbon material having a pore volume and a volume of water greater than the pore volume. In some embodiments, the hydrated carbon material powder is a powder that is not dissolved or suspended in a solvent or carrier medium, but exists as isolated solid particles with no additional additives. That is, in some embodiments, the volume of water is absorbed only by the porous carbon material.

In certain related embodiments of the foregoing, the hydrated carbon material powder comprises activated carbon. In certain embodiments, the hydrated carbon material powder comprises crystalline carbon material, amorphous carbon material, or combinations thereof. In certain embodiments, the hydrated carbon material powder comprises synthetic carbon material. In some embodiments, the hydrated carbon material powder and/or the porous carbon material is ultrapure. In some embodiments, the hydrated carbon material powder and/or porous carbon material is a pyrolyzed dried polymer gel, for example, a pyrolyzed polymer cryogel, a pyrolyzed polymer xerogel or a pyrolyzed polymer aerogel. In other embodiments, the carbon material is pyrolyzed and activated (e.g., a synthetic activated carbon material). For example, in further embodiments the hydrated carbon material powder and/or the porous carbon material is an activated dried polymer gel, an activated polymer cryogel, an activated polymer xerogel or an activated polymer aerogel.

In some embodiments, the surface functionality of the carbon material can be ascertained by and related to pH. For such embodiments, the pH of the carbon can be greater than pH 6.0, greater than pH 7.0, greater than pH 8.0, greater than pH 9.0, greater than pH 10.0, greater than pH 11.0. In certain embodiments, the carbon material has a pH between pH 6.0 and pH 11.0, between pH 6.0 and pH 10.0, between pH 7.0 and pH 9.0, between pH 8.0 and pH 10.0, between pH 7.0 and pH 9.0, between pH 6.0 and pH 7.0, between pH 7.0 and pH 8.0, or between pH 8.0 and pH 9.0. In some embodiments, the carbon material has a pH between 8 and 9, 7.5 and 9.5, 7 and 10, 6.5 and 8, from 6.5 and 8.5, 6 and 10 6.5 and 7.5, 6 and 9, or 5 and 10. In some embodiments the pH of the carbon material is about 8.5, about 7.5, about 7.0, or about 8.5.

In some embodiments, the hydrated carbon material powder has a water content greater than 1%, greater than 5%, greater than 7%, greater than 10%, greater than 12%, greater than 15%, greater than 17%, greater than 20%, greater than 22%, greater than 25%, greater than 30%, greater than 32%, greater than 35%, greater than 37%, greater than 40%, greater than 42%, greater than 45%, greater than 47%, greater than 50%, greater than 52%, greater than 55%, greater than 57%, greater than 60%, greater than 62%, or greater than 65% w/w based on the total weight of the hydrated carbon material powder. In certain embodiments, the hydrated carbon material powder has a water content up to about 99%, about 90%, about 85%, about 80%, about 75%, about 70%, about 65%, about 60%, about 55%, about 50% or about 45%.

In certain embodiments, the hydrated carbon material powder has a water content ranging from 30% to 70% based on total weight of the hydrated carbon material powder. In some embodiments, the hydrated carbon material powder has a water content ranging from 1% to 99%, from 5% to 90%, from 10% to 87%, from 15% to 85%, from 20% to 85%, from 22% to 80%, from 25% to 77%, from 27% to 75% or from 30% to 72% based on total weight of the hydrated carbon material powder.

In certain embodiments, the volume of water is greater than the pore volume of the porous carbon material. In some embodiments, the volume of water is at least 1%, at least 2%, at least 3%, at least 4%, at least 5%, at least 6%, at least 7%, at least 8%, at least 9%, at least 10%, at least 12%, at least 15%, at least 17%, at least 20%, at least 22%, at least 25%, at least 27%, at least 30%, at least 32%, at least 35%, at least 37%, at least 40%, at least 42%, at least 45%, at least 47%, at least 50%, or at least 60% greater than the pore volume. In some embodiments, the volume of water is greater than the pore volume of the porous carbon material. In some embodiments, the volume of water is at least 10%, at least 20%, at least 30%, at least 40%, at least 50%, at least 60%, at least 70%, at least 80%, at least 90%, at least 100%, at least 75%, at least 125%, at least 150%, at least 175% or at least 200% greater than the pore volume.

In some embodiments, the volume of water ranges from 10% to 90% greater than the pore volume. In some embodiments, the volume of water ranges from 10% to 75% greater than the pore volume. In some embodiments, the volume of water ranges from 10% to 50% greater than the pore volume. In some embodiments, the volume of water ranges from 10% to 50% greater than the pore volume. In more specific embodiments, the volume of water ranges from 20% to 30% greater than the pore volume. In more specific embodiments, the volume of water ranges from 40% to 50% greater than the pore volume. In some embodiments, the volume of water ranges from 10% to 70%, from 10% to 65%, from 10% to 60%, from 12% to 57%, from 15% to 55%, from 17% to 52%, from 20% to 50%, from 22% to 50%, from 25% to 50%, from 27% to 50%, from 30% to 50%, from 32% to 50%, from 35% to 50% or from 37% to 55% greater than the pore volume.

In some specific embodiments, the volume of water ranges from 30% to 50%, from 35% to 45%, or 37% to 42% greater than the pore volume. For example, in one specific embodiment, the volume of water ranges is about 40% greater than the pore volume. In some embodiments, the volume of water ranges is about 60%, about 70%, about 80% or about 90% greater than the pore volume (e.g., as calculated by Equation 1).

In some specific embodiments, the volume of water ranges from 60% to 80%, from 65% to 75%, or 67% to 72% greater than the pore volume. For example, in one specific embodiment, the volume of water ranges is about 70% greater than the pore volume.

In some specific embodiments, the volume of water ranges from 45% to 65%, from 50% to 60%, or 52% to 57% greater than the pore volume. For example, in one specific embodiment, the volume of water ranges is about 55% greater than the pore volume. The hydrated carbon material powder of the present disclosure can be characterized in terms of its porosity. Accordingly, in some embodiments, the hydrated carbon material powder has irregular porosity. In certain embodiments, the hydrated carbon material powder comprises an optimized pore size distribution, for example, an optimized blend of both micropores and mesopores. In certain embodiments, the hydrated carbon material powder is mesoporous. In other embodiments, the hydrated carbon material powder is microporous.

Pore structure is typically described in terms of fraction (percent) of the pore volume residing in either micropores or mesopores or both. Thus, in some embodiments the pore structure of the hydrated carbon material powder comprises from 10% to 90% micropores. In some other embodiments the pore structure of the hydrated carbon material powder comprises from 20% to 80% micropores. In other embodiments, the pore structure of the hydrated carbon material powder comprises from 30% to 70% micropores. In other embodiments, the pore structure of the hydrated carbon material powder comprises from 40% to 60% micropores. In other embodiments, the pore structure of the hydrated carbon material powder comprises from 40% to 50% micropores. In other embodiments, the pore structure of the hydrated carbon material powder comprises from 43% to 47% micropores. In certain embodiments, the pore structure of the hydrated carbon material powder comprises about 45% micropores.

In certain embodiments, the pore structure of the hydrated carbon material powder comprises greater than 10% micropores, greater than 20% micropores, greater than 30% micropores, greater than 40% micropores, greater than 50% micropores, greater than 60% micropores, greater than 70% micropores, greater than 80% micropores, greater than 90% micropores, or greater than 99% micropores. In some embodiments, the pore structure of the hydrated carbon material powder comprises 100% micropores.

In certain embodiments, the pore structure of the hydrated carbon material powder comprises greater than 10% mesopores, greater than 20% mesopores, greater than 30% mesopores, greater than 40% mesopores, greater than 50% mesopores, greater than 60% mesopores, greater than 70% mesopores, greater than 80% mesopores, greater than 90% mesopores, or greater than 99% mesopores. In some embodiments, the pore structure of the hydrated carbon material powder comprises 100% mesopores. In some other embodiments the pore structure of the hydrated carbon material powder comprises from 20% to 50% micropores. In still other embodiments the pore structure of the hydrated carbon material powder comprises from 20% to 40% micropores, for example from 25% to 35% micropores or 27% to 33% micropores. In some other embodiments, the pore structure of the hydrated carbon material powder comprises from 30% to 50% micropores, for example from 35% to 45% micropores or 37% to 43% micropores. In some certain embodiments, the pore structure of the hydrated carbon material powder comprises about 30% micropores or about 40% micropores.

In one particular embodiment, the hydrated carbon material powder has a pore structure comprising micropores, mesopores and a total pore volume, and wherein from 40% to 90% of the total pore volume resides in micropores, from 10% to 60% of the total pore volume resides in mesopores and less than 10% of the total pore volume resides in pores greater than 30 nm.

In certain specific embodiments, the pore volume comprises pores having diameters ranging from greater than 0 nm to 50 nm. In more specific embodiments, greater than 50% of the pore volume resides in pores having diameters from 2 nm to 50 nm. In some embodiments, greater than 5%, greater than 7%, greater than 10%, greater than 12%, greater than 15%, greater than 17%, greater than 20%, greater than 22%, greater than 25%, greater than 27%, greater than 30%, greater than 32%, greater than 35%, greater than 37%, greater than 40%, greater than 42%, greater than 45%, greater than 47% or greater than 55% of the pore volume resides in pores having diameters from 2 nm to 50 nm. In some specific embodiments, greater than 50% of the pore volume resides in pores having diameters greater than 0 nm to less than 2 nm. In some embodiments, greater than 5%, greater than 7%, greater than 10%, greater than 12%, greater than 15%, greater than 17%, greater than 20%, greater than 22%, greater than 25%, greater than 27%, greater than 30%, greater than 32%, greater than 35%, greater than 37%, greater than 40%, greater than 42%, greater than 45%, greater than 47% or greater than 55% of the pore volume resides in pores having diameters greater than 0 nm to less than 2 nm.

In some embodiments, greater than 10%, greater than 20%, greater than 30%, greater than 40%, greater than 50%, greater than 60%, greater than 70%, greater than 80%, greater than 90%, or greater than 99% of the pore volume resides in pores having diameters ranging from about 20 Å to about 300 Å. In some embodiments, 100% of the pore volume resides in pores having diameters ranging from about 20 Å to about 300 Å.

In one embodiment, the hydrated carbon material powder comprises a fractional pore volume of pores at or below 100 nm that comprises at least 50% of the pore volume, at least 75% of the pore volume, at least 90% of the pore volume or at least 99% of the pore volume. In other embodiments, the hydrated carbon material powder comprises a fractional pore volume of pores at or below 20 nm that comprises at least 50% of the pore volume, at least 75% of the pore volume, at least 90% of the pore volume or at least 99% of the pore volume.

In another embodiment, the hydrated carbon material powder comprises a fractional pore surface area of pores at or below 100 nm that comprises at least 50% of the total pore surface area, at least 75% of the total pore surface area, at least 90% of the total pore surface area or at least 99% of the total pore surface area. In another embodiment, the hydrated carbon material powder comprises a fractional pore surface area of pores at or below 20 nm that comprises at least 50% of the total pore surface area, at least 75% of the total pore surface area, at least 90% of the total pore surface area or at least 99% of the total pore surface area.

In some other embodiments the pore structure of the hydrated carbon material powder comprises from 20% to 50% micropores. In still other embodiments the pore structure of the hydrated carbon material powder comprises from 20% to 40% micropores, for example from 25% to 35% micropores or 27% to 33% micropores. In some other embodiments, the pore structure of the hydrated carbon material powder comprises from 30% to 50% micropores, for example from 35% to 45% micropores or 37% to 43% micropores. In some certain embodiments, the pore structure of the hydrated carbon material powder comprises about 30% micropores or about 40% micropores.

In some other embodiments the pore structure of the hydrated carbon material powder comprises from 40% to 90% micropores. In still other embodiments the pore structure of the hydrated carbon material powder comprises from 45% to 90% micropores, for example from 55% to 85% micropores. In some other embodiments, the pore structure of the hydrated carbon material powder comprises from 65% to 85% micropores, for example from 75% to 85% micropores or 77% to 83% micropores. In yet other embodiments the pore structure of the hydrated carbon material powder comprises from 65% to 75% micropores, for example from 67% to 73% micropores. In some certain embodiments, the pore structure of the hydrated carbon material powder comprises about 80% micropores or about 70% micropores.

In some embodiments, the pore structure of the hydrated carbon material powder comprises from 10% to 90% mesopores. In some other embodiments, the pore structure of the hydrated carbon material powder comprises from 20% to 80% mesopores. In other embodiments, the pore structure of the hydrated carbon material powder comprises from 30% to 70% mesopores. In other embodiments, the pore structure of the hydrated carbon material powder comprises from 40% to 60% mesopores. In other embodiments, the pore structure of the hydrated carbon material powder comprises from 50% to 60% mesopores. In other embodiments, the pore structure of the hydrated carbon material powder comprises from 53% to 57% mesopores. In other embodiments, the pore structure of the hydrated carbon material powder comprises about 55% mesopores.

In some other embodiments the pore structure of the hydrated carbon material powder comprises from 50% to 80% mesopores. In still other embodiments the pore structure of the hydrated carbon material powder comprises from 60% to 80% mesopores, for example from 65% to 75% mesopores or 67% to 73% mesopores. In some other embodiments, the pore structure of the hydrated carbon material powder comprises from 50% to 70% mesopores, for example from 55% to 65% mesopores or 57% to 53% mesopores. In some certain embodiments, the pore structure of the hydrated carbon material powder comprises about 30% mesopores or about 40% mesopores.

In some other embodiments the pore structure of the hydrated carbon material powder comprises from 10% to 60% mesopores. In some other embodiments the pore structure of the hydrated carbon material powder comprises from 10% to 55% mesopores, for example from 15% to 45% mesopores or from 15% to 40% mesopores. In some other embodiments, the pore structure of the hydrated carbon material powder comprises from 15% to 35% mesopores, for example from 15% to 25% mesopores or from 17% to 23% mesopores. In some other embodiments, the pore structure of the hydrated carbon material powder comprises from 25% to 35% mesopores, for example from 27% to 33% mesopores. In some certain embodiments, the pore structure of the hydrated carbon material powder comprises about 20% mesopores and in other embodiments the hydrated carbon material powder comprises about 30% mesopores.

In some embodiments the pore structure of the hydrated carbon material powder comprises from 10% to 90% micropores and from 10% to 90% mesopores. In some other embodiments the pore structure of the hydrated carbon material powder comprises from 20% to 80% micropores and from 20% to 80% mesopores. In other embodiments, the pore structure of the hydrated carbon material powder comprises from 30% to 70% micropores and from 30% to 70% mesopores. In other embodiments, the pore structure of the hydrated carbon material powder comprises from 40% to 60% micropores and from 40% to 60% mesopores. In other embodiments, the pore structure of the hydrated carbon material powder comprises from 40% to 50% micropores and from 50% to 60% mesopores. In other embodiments, the pore structure of the hydrated carbon material powder comprises from 43% to 47% micropores and from 53% to 57% mesopores. In other embodiments, the pore structure of the hydrated carbon material powder comprises about 45% micropores and about 55% mesopores.

In still other embodiments, the pore structure of the hydrated carbon material powder comprises from 40% to 90% micropores and from 10% to 60% mesopores. In other embodiments, the pore structure of the hydrated carbon material powder comprises from 45% to 90% micropores and from 10% to 55% mesopores. In other embodiments, the pore structure of the hydrated carbon material powder comprises from 40% to 85% micropores and from 15% to 40% mesopores. In yet other embodiments, the pore structure of the hydrated carbon material powder comprises from 55% to 85% micropores and from 15% to 45% mesopores, for example from 65% to 85% micropores and from 15% to 35% mesopores. In other embodiments, the pore structure of the hydrated carbon material powder comprises from 65% to 75% micropores and from 15% to 25% mesopores, for example from 67% to 73% micropores and from 27% to 33% mesopores In some other embodiments, the pore structure of the hydrated carbon material powder comprises from 75% to 85% micropores and from 15% to 25% mesopores, for example from 83% to 77% micropores and from 17% to 23% mesopores. In other certain embodiments, the pore structure of the hydrated carbon material powder comprises about 80% micropores and about 20% mesopores, or in other embodiments, the pore structure of the hydrated carbon material powder comprises about 70% micropores and about 30% mesopores.

In still other embodiments, the pore structure of the hydrated carbon material powder comprises from 20% to 50% micropores and from 50% to 80% mesopores. For example, in some embodiments, from 20% to 40% of the pore volume resides in micropores and from 60% to 80% of the pore volume resides in mesopores. In other embodiments, from 25% to 35% of the pore volume resides in micropores and from 65% to 75% of the pore volume resides in mesopores. For example, in some embodiments about 30% of the pore volume resides in micropores and about 70% of the pore volume resides in mesopores.

In still other embodiments, from 30% to 50% of the pore volume resides in micropores and from 50% to 70% of the pore volume resides in mesopores. In other embodiments, from 35% to 45% of the pore volume resides in micropores and from 55% to 65% of the pore volume resides in mesopores. For example, in some embodiments, about 40% of the pore volume resides in micropores and about 60% of the pore volume resides in mesopores.

In other variations of any of the foregoing hydrated carbon material powder, the hydrated carbon material powder does not have a substantial volume of pores greater than 20 nm or 30 nm. For example, in certain embodiments the hydrated carbon material powder comprise less than 50%, less than 40%, less than 30%, less than 25%, less than 20%, less than 15%, less than 10%, less than 5%, less than 2.5% or even less than 1% of the pore volume in pores greater than 20 nm or 30 nm.

In one embodiment the hydrated carbon material powder comprises a pore volume residing in pores less than 20 angstroms of at least 1.8 cc/g, at least 1.2 cc/g, at least 0.60 cc/g, at least 0.30 cc/g, at least 0.25 cc/g, at least 0.20 cc/g or at least 0.15 cc/g based on weight of the porous carbon material in the absence of the water. In other embodiments, the hydrated carbon material powder comprises a pore volume residing in pores greater than 20 angstroms of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, at least 1.80 cc/g, at least 1.70 cc/g, at least 1.60 cc/g, at least 1.50 cc/g, at least 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.5 cc/g, at least 0.4 cc/g, at least 0.3 cc/g, at least 0.4 cc/g, at least 0.3 cc/g, at least 0.2 cc/g, at least 0.1 cc/g, at least 0.075 cc/g, at least 0.05 cc/g, at least 0.025 cc/g, at least 0.01 cc/g based on weight of the porous carbon material in the absence of the water.

In other embodiments, the hydrated carbon material powder comprises a pore volume greater than 4.00 cc/g, greater than 3.75 cc/g, greater than 3.50 cc/g, greater than 3.25 cc/g, greater than 3.00 cc/g, greater than 2.75 cc/g, greater than 2.50 cc/g, greater than 2.25 cc/g, greater than 2.00 cc/g, greater than 1.90 cc/g, greater than 1.80 cc/g, greater than 1.70 cc/g, greater than 1.60 cc/g, greater than 1.50 cc/g, greater than 1.40 cc/g, greater than 1.30 cc/g, greater than 1.20 cc/g, greater than 1.10 cc/g, greater than 1.00 cc/g, greater than 0.85 cc/g, greater than 0.80 cc/g, greater than 0.75 cc/g, greater than 0.70 cc/g, greater than 0.65 cc/g or greater than 0.50 cc/g for pores ranging from 20 angstroms to 300 angstroms based on weight of the porous carbon material in the absence of the water.

In other embodiments, the hydrated carbon material powder comprises a pore volume greater than 4.00 cc/g, greater than 3.75 cc/g, greater than 3.50 cc/g, greater than 3.25 cc/g, greater than 3.00 cc/g, greater than 2.75 cc/g, greater than 2.50 cc/g, greater than 2.25 cc/g, greater than 2.00 cc/g, greater than 1.90 cc/g, greater than 1.80 cc/g, greater than 1.70 cc/g, greater than 1.60 cc/g, greater than 1.50 cc/g, greater than 1.40 cc/g, greater than 1.30 cc/g, greater than 1.20 cc/g, greater than 1.10 cc/g, greater than 1.00 cc/g, greater than 0.85 cc/g, greater than 0.80 cc/g, greater than 0.75 cc/g, greater than 0.70 cc/g, greater than 0.65 cc/g, greater than 0.50 cc/g, at least 0.4 cc/g, at least 0.3 cc/g, at least 0.2 cc/g, at least 0.1 cc/g, at least 0.075 cc/g, at least 0.05 cc/g, at least 0.025 cc/g, at least 0.01 cc/g for pores ranging from 20 angstroms to 500 angstroms based on weight of the porous carbon material in the absence of the water.

In yet other embodiments, the hydrated carbon material powder comprises a pore volume greater than 4.00 cc/g, greater than 3.75 cc/g, greater than 3.50 cc/g, greater than 3.25 cc/g, greater than 3.00 cc/g, greater than 2.75 cc/g, greater than 2.50 cc/g, greater than 2.25 cc/g, greater than 2.00 cc/g, greater than 1.90 cc/g, greater than 1.80 cc/g, greater than 1.70 cc/g, greater than 1.60 cc/g, greater than 1.50 cc/g, greater than 1.40 cc/g, greater than 1.30 cc/g, greater than 1.20 cc/g, greater than 1.10 cc/g, greater than 1.00 cc/g, greater than 0.85 cc/g, greater than 0.80 cc/g, greater than 0.75 cc/g, greater than 0.70 cc/g, greater than 0.65 cc/g, greater than 0.60 cc/g, greater than 0.55 cc/g, greater than 0.50 cc/g, greater than 0.45 cc/g, greater than 0.40 cc/g, greater than 0.35 cc/g, greater than 0.30 cc/g, greater than 0.25 cc/g, greater than 0.20 cc/g, greater than 0.10 cc/g, greater than 0.05 cc/g, or greater than 0.025 cc/g based on weight of the porous carbon material in the absence of the water.

In certain embodiments, the pore volume ranges from 0.3 cc/g to 1.5 cc/g, from 0.3 cc/g to 0.7 cc/g or from 1.0 cc/g to 1.5 cc/g based on weight of the porous carbon material in the absence of the water. In certain embodiments, the pore volume ranges from 0.1 cc/g to 5.0 cc/g, from 0.1 cc/g to 3.5 cc/g, from 0.2 cc/g to 2.0 cc/g, from 0.5 cc/g to 1.5 cc/g, from 0.5 cc/g to 1.3 cc/g, from 0.9 cc/g to 1.2 cc/g or from 1.0 cc/g to 2.0 cc/g.

In certain embodiments, the pore volume ranges from 0.5 cc/g to 0.9 cc/g, from 0.60 cc/g to 0.80 cc/g or from 0.65 cc/g to 0.75 cc/g based on weight of the porous carbon material in the absence of the water. In certain embodiments, the pore volume is about 0.7 cc/g based on weight of the porous carbon material in the absence of the water.

In certain embodiments, the pore volume ranges from 1.10 cc/g to 1.50 cc/g, from 1.20 cc/g to 1.40 cc/g or from 1.25 cc/g to 1.35 cc/g based on weight of the porous carbon material in the absence of the water. In certain embodiments, the pore volume is about 1.30 cc/g based on weight of the porous carbon material in the absence of the water.

In one embodiment the hydrated carbon material powder comprises a pore volume of at least 0.35 cc/g, at least 0.30 cc/g, at least 0.25 cc/g, at least 0.20 cc/g or at least 0.15 cc/g for pores less than 20 angstroms based on weight of the porous carbon material in the absence of the water. In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores greater than 20 angstroms based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 500 angstroms based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 1000 angstroms based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 2000 angstroms based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 5000 angstroms based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 1 micron based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 2 microns based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 3 microns based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 4 microns based on weight of the porous carbon material in the absence of the water.

In other embodiments, the hydrated carbon material powder comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 5 microns based on weight of the porous carbon material in the absence of the water.

In yet other embodiments, the hydrated carbon material powder comprises a total pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g , 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g based on weight of the porous carbon material in the absence of the water.

In some embodiments, the hydrated carbon material powder has a total (BET) pore volume ranging from 0.675 to 0.755 cc/g, from 0.665 to 0.765 cc/g, or from 0.5 to 1.0 cc/g. In one particular embodiment, the hydrated carbon material powder has a total (BET) pore volume of about 0.715 cc/g.

In some embodiments, the hydrated carbon material powder has a total (BET) pore volume ranging from 1.09 to 1.49 cc/g, from 0.89 to 1.69 cc/g, or from 0.69 to 1.89 cc/g. In one particular embodiment, the hydrated carbon material powder has a total (BET) pore volume of about 1.29 cc/g.

In some embodiments, the hydrated carbon material powder has a total (BET) pore volume ranging from 0.650 to 0.750 cc/g, from 0.630 to 0.780 cc/g, or from 0.5 to 0.90 cc/g. In one particular embodiment, the hydrated carbon material powder has a total (BET) pore volume of about 0.700 cc/g.

In some embodiments, the hydrated carbon material powder has a total (BET) pore volume ranging from 1.05 to 1.35 cc/g, from 0.85 to 1.55 cc/g, or from 0.65 to 1.75 cc/g. In one particular embodiment, the hydrated carbon material powder has a total (BET) pore volume of about 1.15 cc/g.

In yet other embodiments, the hydrated carbon material powder comprises a pore volume residing in pores of less than 20 angstroms of at least 0.2 cc/g and a pore volume residing in pores of between 20 and 300 angstroms of at least 0.8 cc/g based on weight of the porous carbon material in the absence of the water. In yet other embodiments, the hydrated carbon material powder comprises a pore volume residing in pores of less than 20 angstroms of at least 0.5 cc/g and a pore volume residing in pores of between 20 and 300 angstroms of at least 0.5 cc/g based on weight of the porous carbon material in the absence of the water. In yet other embodiments, the hydrated carbon material powder comprises a pore volume residing in pores of less than 20 angstroms of at least 0.6 cc/g and a pore volume residing in pores of between 20 and 300 angstroms of at least 2.4 cc/g based on weight of the porous carbon material in the absence of the water. In yet other embodiments, the carbon material powder comprises a pore volume residing in pores of less than 20 angstroms of at least 1.5 cc/g and a pore volume residing in pores of between 20 and 300 angstroms of at least 1.5 cc/g based on weight of the porous carbon material in the absence of the water.

In yet other embodiments, the hydrated carbon material powder comprises a pore volume residing in pores of less than 20 angstroms of at least 0.2 cc/g and a pore volume residing in pores of between 20 and 500 angstroms of at least 0.8 cc/g based on weight of the porous carbon material in the absence of the water. In yet other embodiments, the hydrated carbon material powder comprises a pore volume residing in pores of less than 20 angstroms of at least 0.5 cc/g and a pore volume residing in pores of between 20 and 500 angstroms of at least 0.5 cc/g based on weight of the porous carbon material in the absence of the water. In yet other embodiments, the hydrated carbon material powder comprises a pore volume residing in pores of less than 20 angstroms of at least 0.6 cc/g and a pore volume residing in pores of between 20 and 500 angstroms of at least 2.4 cc/g based on weight of the porous carbon material in the absence of the water. In yet other embodiments, the carbon material powder comprises a pore volume residing in pores of less than 20 angstroms of at least 1.5 cc/g and a pore volume residing in pores of between 20 and 500 angstroms of at least 1.5 cc/g based on weight of the porous carbon material in the absence of the water.

In certain embodiments, hydrated carbon material powder comprising a mesoporous carbon material having low pore volume in the micropore region (e.g., less than 60%, less than 50%, less than 40%, less than 30%, less than 20% microporosity) is provided. For example, the mesoporous carbon can be a polymer gel that has been pyrolyzed, but not activated. In some embodiments, the pyrolyzed mesoporous carbon comprises a specific surface area of at least 400 m²/g, at least 500 m²/g, at least 600 m²/g, at least 675 m²/g or at least 750 m²/g. In other embodiments, the mesoporous carbon material comprises a pore volume of at least 0.50 cc/g, at least 0.60 cc/g, at least 0.70 cc/g, at least 0.80 cc/g or at least 0.90 cc/g. In yet other embodiments, the mesoporous carbon material comprises a tap density of at least 0.30 g/cc, at least 0.35 g/cc, at least 0.40 g/cc, at least 0.45 g/cc, at least 0.50 g/cc or at least 0.55 g/cc.

In some embodiments, the porous carbon material has about 93% of the total pore volume residing in micropores or in pores having a pore diameter ranging from about 0 to 20 angstroms. In some embodiments, 91% to 95%, 89% to 98%, or 85% to 100% of the total pore volume of the porous carbon material resides in micropores or in pores having a pore diameter ranging from about 0 to 20 angstroms.

In some embodiments, the porous carbon material has about 7% of the total pore volume residing in mesopores or in pores having a pore diameter ranging from about 20 to 300 angstroms. In some embodiments, 5% to 9%, 2% to 11%, or 0% to 15% of the total pore volume of the porous carbon material resides in mesopores or in pores having a pore diameter ranging from about 20 to 300 angstroms.

In certain embodiments, hydrated carbon material powder comprising a mesoporous carbon material having low pore volume in the mesopore region (e.g., less than 60%, less than 50%, less than 40%, less than 30%, less than 20% mesoporosity) is provided. In some embodiments, the porous carbon material comprises a specific surface area of at least 500 m²/g, at least 1000 m²/g, at least 1500 m²/g, at least 1600 m²/g or at least 1690 m²/g. In other embodiments, the mesoporous carbon material comprises a pore volume of at least 0.70 cc/g, at least 0.80 cc/g, at least 0.90 cc/g, at least 1.00 cc/g or at least 1.20 cc/g. In yet other embodiments, the mesoporous carbon material comprises a tap density of at least 0.10 g/cc, at least 0.15 g/cc, at least 0.20 g/cc, at least 0.25 g/cc, at least 0.30 g/cc or at least 0.35 g/cc.

In another embodiment, the hydrated carbon material powder comprises porous carbon material comprising a tap density between 0.1 and 1.0 g/cc, between 0.2 and 0.6 g/cc, between 0.2 and 0.8 g/cc, between 0.3 and 0.5 g/cc or between 0.4 and 0.5 g/cc based on weight of the porous carbon material in the absence of the water. In another embodiment, the hydrated carbon material powder has a pore volume of at least 0.1 cm³/g , at least 0.2 cm³/g , at least 0.3 cm³/g, at least 0.4 cm³/g, at least 0.5 cm³/g, at least 0.7 cm³/g, at least 0.75 cm³/g, at least 0.9 cm³/g, at least 1.0 cm³/g, at least 1.1 cm³/g, at least 1.2 cm³/g, at least 1.3 cm³/g, at least 1.4 cm³/g, at least 1.5 cm³/g or at least 1.6 cm³/g based on weight of the porous carbon material in the absence of the water.

In some embodiments, the hydrated carbon material powder comprises porous carbon material having a tap density between 0.25 to 0.30 cm³/g, 0.20 to 0.35 cm³/g, 0.10 to 0.45 cm³/g, 0.38 to 0.43 cm³/g, 0.35 to 0.45 cm³/g, 0.25 to 0.50 cm³/g, 0.53 to 0.58 cm³/g, 0.50 to 0.62 cm³/g, 0.45 to 0.65 cm³/g, 0.38 to 0.53 cm³/g, or 0.30 to 0.60 cm³/g.

In another embodiment, the hydrated carbon material powder comprises a fractional pore surface area of pores between 20 and 300 angstroms that comprises at least 40% of the total pore surface area, at least 50% of the total pore surface area, at least 70% of the total pore surface area or at least 80% of the total pore surface area. In another embodiment, the hydrated carbon material powder comprises a fractional pore surface area of pores at or below 20 nm that comprises at least 20% of the total pore surface area, at least 30% of the total pore surface area, at least 40% of the total pore surface area or at least 50% of the total pore surface area.

In another embodiment, the hydrated carbon material powder comprises a fractional pore surface area of pores between 20 and 500 angstroms that comprises at least 40% of the total pore surface area, at least 50% of the total pore surface area, at least 70% of the total pore surface area or at least 80% of the total pore surface area. In another embodiment, the hydrated carbon material powder comprises a fractional pore surface area of pores at or below 20 angstroms that comprises at least 20% of the total pore surface area, at least 30% of the total pore surface area, at least 40% of the total pore surface area or at least 50% of the total pore surface area.

In another embodiment, the hydrated carbon material powder comprises pores predominantly in the range of 1000 angstroms or lower, for example 100 angstroms or lower, for example 50 angstroms or lower. In alternative embodiments, the hydrated carbon material powder comprises micropores in the ranging from 0 to 20 angstroms and mesopores in the ranging from 20 to 300 angstroms. In some embodiments, the ratio of pore volume or pore surface in the micropore range compared to the mesopore range can be in the range of 95:5 to 5:95. Alternatively, in some embodiments the ratio of pore volume or pore surface in the micropore range compared to the mesopore range can be in the range of 20:80 to 60:40.

In other embodiments, the hydrated carbon material powder is mesoporous and comprises monodisperse mesopores. As used herein, the term “monodisperse” when used in reference to a pore size refers generally to a span (further defined as (Dv90−Dv10)/Dv, 50 where Dv10, Dv50 and Dv90 refer to the pore size at 10%, 50% and 90% of the distribution by volume of about 3 or less, typically about 2 or less, often about 1.5 or less.

Yet in other embodiments, the hydrated carbon material powder comprises a pore volume of at least 1 cc/g, at least 2 cc/g, at least 3 cc/g, at least 4 cc/g or at least 7 cc/g based on weight of the porous carbon material in the absence of the water. In one particular embodiment, the hydrated carbon material powder comprises a pore volume ranging from 1 cc/g to 7 cc/g based on weight of the porous carbon material in the absence of the water.

In other embodiments of the hydrated carbon material powder, at least 50% of the pore volume resides in pores with a diameter ranging from 50 Å to 5000 Å. In some embodiments of the hydrated carbon material powder, at least 50% of the pore volume resides in pores with a diameter ranging from 50 Å to 500 Å. Still in other instances of the hydrated carbon material powder, at least 50% of the pore volume resides in pores with a diameter ranging from 500 Å to 1000 Å. Yet in other instances of the hydrated carbon material powder, at least 50% of the pore volume resides in pores with a diameter ranging from 1000 Å to 5000 Å.

In some embodiments, about 40% to about 60% of the total pore volume resides in micropores and about 40% to about 60% of the total pore volume resides in mesopores.

In some embodiments, the mean particle diameter for the hydrated carbon material powder ranges from 1 to 1000 microns. In other embodiments the mean particle diameter for the hydrated carbon material powder ranges from 1 to 100 microns. Still in other embodiments the mean particle diameter for the hydrated carbon material powder ranges from 1 to 50 microns, from 1 to 60 microns, or from 1 to 70 microns (e.g., about 8.5 microns, about 60 microns). Yet in other embodiments, the mean particle diameter for the hydrated carbon material powder ranges from 5 to 15 microns or from 1 to 5 microns. Still in other embodiments, the mean particle diameter for the hydrated carbon material powder is about 10 microns. Still in other embodiments, the mean particle diameter for the hydrated carbon material powder is less than 4, is less than 3, is less than 2, is less than 1 micron(s).

In some embodiments, the D(50) for the hydrated carbon material powder ranges from 1 to 1000 microns. In other embodiments the D(50) for the hydrated carbon material powder ranges from 1 to 100 microns. Still in other embodiments the D(50) for the hydrated carbon material powder ranges from 1 to 50 microns, from 1 to 60 microns, or from 1 to 70 microns (e.g., about 8.5 microns, about 60 microns). Yet in other embodiments, the D(50) for the hydrated carbon material powder ranges from 5 to 15 microns or from 1 to 5 microns. Still in other embodiments, the D(50) for the hydrated carbon material powder is about 10 microns. Still in other embodiments, the D(50) for the hydrated carbon material powder is less than 4, is less than 3, is less than 2, is less than 1 micron(s).

In some embodiments, the D(50) particle size ranges from about 7.5 to 9.5, from 7 to 10, from 2 to 12, from 45 to 75, from 40 to 80, from 10 to 100, from 25 to 100, from 20 to 100, or from 50 to 100 microns. In some embodiments, the D(50) particle size is about 8.5 or about 60 microns. In some embodiments, the D(50) particle size is about 8.5 or about 60 microns.

Advantageously, in some embodiments, the relatively large particle size of the hydrated carbon material powder reduces aggregation and provides for excellent dispersity within other mixtures or compositions (e.g., a lead acid paste). In this respect, the carbon material powder as disclosed herein can exist within the composition as discrete particles (e.g., not aggregated to form a higher order structure). In some embodiments, the particle size is determined by optical microscopy, laser diffraction, scanning electron microscopy or combinations thereof In some embodiments, aggregation may be determined as several particles all being in relatively close proximity or touching to form a larger collective or higher order structure. In some embodiments, close proximity may be within 1-2 nm, 1-3 nm, 1-4 nm, 1-5 nm, or 1-10 nm. In another aspect, the carbon material has an aggregate or cluster size less than about 100 microns, about 90 microns, about 80 microns, about 70 microns, about 60 microns, about 50 microns, about 40 microns, about 30 microns, about 25 microns, about 20 microns, about 15 microns, or about 10 microns. In another aspect, the carbon material has an aggregate or cluster size less than about 100 microns, about 200 microns, about 300 microns, about 400 microns, about 500 microns, about 600 microns, about 700 microns, about 800 microns, about 900 microns, about 1000 microns, about 1100 microns, about 1200 microns, about 1300 microns, about 1400 microns, about 1500 microns, about 1600 microns, about 1700 microns, about 1800 microns, about 1900 microns, or about 2000 microns.

Accordingly, in some embodiments, the hydrated carbon material powder has a D(50) of greater than 2 microns, 5 microns, 8.5 microns, 9 microns, 10 microns, greater than 15 microns, greater than 20 microns, greater than 25 microns, greater than 30 microns, greater than 35 microns, greater than40 microns, greater than 45 microns, greater than 50 microns, greater than 55 microns, greater than 60 microns, greater than 65 microns, greater than 70 microns, greater than 75 microns, or greater than 80 microns.

In some embodiments, the hydrated carbon material powder has a D(50) ranging from about 25 to about 200 microns, from about 30 to about 200 microns, from about 35 to about 200 microns, from about 40 to about 200 microns, from about 45 to about 200 microns, from about 50 to about 200 microns, from about 55 to about 200 microns, from about 60 to about 200 microns, from about 65 to about 200 microns, from about 70 to about 200 microns, from about 75 to about 200 microns, from about 80 to about 200 microns, from about 85 to about 200 microns, from about 90 to about 175 microns, from about 25 to about 150 microns, from about 25 to about 125 microns, from about 25 to about 100 microns, from about 10 to about 175 microns, from about 10 to about 150 microns, from about 10 to about 125 microns, from about 10 to about 100 microns, from about 10 to about 80 microns, from about 10 to about 70 microns, from about 20 to about 80 microns, from about 30 to about 100 microns, from about 40 to about 100 microns, or from about 50 to about 100 microns.

In some embodiments, the hydrated carbon material powder exhibit a mean particle diameter ranging from 1 nm to 10 nm. In other embodiments, the mean particle diameter ranges from 10 nm to 20 nm. Yet in other embodiments, the mean particle diameter ranges from 20 nm to 30 nm. Still in other embodiments, the mean particle diameter ranges from 30 nm to 40 nm. Yet still in other embodiments, the mean particle diameter ranges from 40 nm to 50 nm. In other embodiments, the mean particle diameter ranges from 50 nm to 100 nm.

In some embodiments, the hydrated carbon material powder exhibit a D(50) ranging from 1 nm to 10 nm. In other embodiments, the D(50) ranges from 10 nm to 20 nm. Yet in other embodiments, the D(50) ranges from 20 nm to 30 nm. Still in other embodiments, the D(50) ranges from 30 nm to 40 nm. Yet still in other embodiments, the D(50) ranges from 40 nm to 50 nm. In other embodiments, the D(50) ranges from 50 nm to 100 nm.

The purity of the porous carbon material in the disclosed hydrated carbon material powder can be determined by any number of techniques known in the art. One particular method useful for determining purity is proton induced x-ray emission (PIXE). This technique is very sensitive and capable of detecting the presence of elements having atomic numbers ranging from 11 to 92 (i.e., PIXE impurities) at the low ppm level. Methods for determining impurity levels via PIXE are well known in the art.

In general, a carbon material of the hydrated carbon material powder may comprise low total PIXE impurities. Thus, in some embodiments the total PIXE impurity content in the hydrated carbon material powder (as measured by proton induced x-ray emission) is less than 1000 ppm. In other embodiments, the porous carbon material comprises a total impurity content of less than 800 ppm, less than 500 ppm, less than 300 ppm, less than 200 ppm, less than 150 ppm, less than 100 ppm, less than 50 ppm, less than 25 ppm, less than 10 ppm, less than 5 ppm or less than 1 ppm of elements having atomic numbers ranging from 11 to 92 as measured by proton induced x-ray emission. In further embodiments of the foregoing, the porous carbon material is a pyrolyzed dried polymer gel, a pyrolyzed polymer cryogel, a pyrolyzed polymer xerogel, a pyrolyzed polymer aerogel, an activated dried polymer gel, an activated polymer cryogel, an activated polymer xerogel or an activated polymer aerogel.

In addition to low content of undesired PIXE impurities, the porous carbon material of the disclosed hydrated carbon material powder may comprise high total carbon content. In addition to carbon, the porous carbon material of the hydrated carbon material powder may also comprise oxygen, hydrogen, nitrogen and electrochemical modifier. In some embodiments, the porous carbon material of the hydrated carbon material powder comprises at least 75% carbon, at least 80% carbon, at least 85% carbon, at least 90% carbon, at least 95% carbon, at least 96% carbon, at least 97% carbon, at least 98% carbon or at least 99% carbon on a weight/weight basis. In some other embodiments, the porous carbon material of the hydrated carbon material powder comprises less than 10% oxygen, less than 5% oxygen, less than 3.0% oxygen, less than 2.5% oxygen, less than 1% oxygen or less than 0.5% oxygen on a weight/weight basis. In other embodiments, the porous carbon material of the hydrated carbon material powder comprises less than 10% hydrogen, less than 5% hydrogen, less than 2.5% hydrogen, less than 1% hydrogen, less than 0.5% hydrogen or less than 0.1% hydrogen on a weight/weight basis. In other embodiments, the porous carbon material of the hydrated carbon material powder comprises less than 5% nitrogen, less than 2.5% nitrogen, less than 1% nitrogen, less than 0.5% nitrogen, less than 0.25% nitrogen or less than 0.01% nitrogen on a weight/weight basis. The oxygen, hydrogen and nitrogen content of the porous carbon materials of the disclosed hydrated carbon material powder can be determined by combustion analysis. Techniques for determining elemental composition by combustion analysis are well known in the art.

In some embodiments, the level of sodium present in the porous carbon material is less than 1000 ppm, less than 500 ppm, less than 100 ppm, less than 50 ppm, less than 10 ppm, or less than 1 ppm.

In some embodiments, the level of magnesium present in the porous carbon material is less than 1000 ppm, less than 100 ppm, less than 50 ppm, less than 10 ppm, or less than 1 ppm.

In some embodiments, the level of aluminum present in the porous carbon material is less than 1000 ppm, less than 100 ppm, less than 50 ppm, less than 10 ppm, or less than 1 ppm.

In some embodiments, the level of silicon present in the porous carbon material is less than 500 ppm, less than 300 ppm, less than 100 ppm, less than 50 ppm, less than 20 ppm, less than 10 ppm or less than 1 ppm.

In some embodiments, the level of phosphorous present in the porous carbon material is less than 1000 ppm, less than 100 ppm, less than 50 ppm, less than 10 ppm, or less than 1 ppm.

In some embodiments, the level of sulfur present in the porous carbon material is less than 1000 ppm, less than 100 ppm, less than 50 ppm, less than 30 ppm, less than 10 ppm, less than 5 ppm or less than 1 ppm.

In some embodiments, the level of chlorine present in porous carbon material is less than 1000 ppm, less than 100 ppm, less than 50 ppm, less than 10 ppm, or less than 1 ppm.

In some embodiments, the level of potassium present in the porous carbon material is less than 1000 ppm, less than 100 ppm, less than 50 ppm, less than 10 ppm, or less than 1 ppm.

In other embodiments, the level of calcium present in the porous carbon material is less than 100 ppm, less than 50 ppm, less than 20 ppm, less than 10 ppm, less than 5 ppm or less than 1 ppm. In some embodiments, the level of chromium present in the porous carbon material is less than 1000 ppm, less than 100 ppm, less than 50 ppm, less than 10 ppm, less than 5 ppm, less than 4 ppm, less than 3 ppm, less than 2 ppm or less than 1 ppm.

In other embodiments, the level of iron present in the porous carbon material is less than 50 ppm, less than 20 ppm, less than 10 ppm, less than 5 ppm, less than 4 ppm, less than 3 ppm, less than 2 ppm or less than 1 ppm.

In other embodiments, the level of nickel present in the porous carbon material is less than 20 ppm, less than 10 ppm, less than 5 ppm, less than 4 ppm, less than 3 ppm, less than 2 ppm or less than 1 ppm.

In some other embodiments, the level of copper present in the porous carbon material is less than 140 ppm, less than 100 ppm, less than 40 ppm, less than 20 ppm, less than 10 ppm, less than 5 ppm, less than 4 ppm, less than 3 ppm, less than 2 ppm or less than 1 ppm.

In yet other embodiments, the level of zinc present in the porous carbon material is less than 20 ppm, less than 10 ppm, less than 5 ppm, less than 2 ppm or less than 1 ppm.

In yet other embodiments, the sum of all PUCE impurities, excluding sodium, magnesium, aluminum, silicon, phosphorous, sulphur, chlorine, potassium, calcium, chromium, iron, nickel, copper and zinc, present in the porous carbon material is less than 1000 ppm, less than 500 pm, less than 300 ppm, less than 200 ppm, less than 100 ppm, less than 50 ppm, less than 25 ppm, less than 10 ppm or less than 1 ppm. In some embodiments other impurities such as hydrogen, oxygen and/or nitrogen may be present in levels ranging from less than 10% to less than 0.01%.

Some embodiments of the porous carbon material comprise undesired PIXE impurities near or below the detection limit of the proton induced x-ray emission analysis. For example, in some embodiments the porous carbon material comprises less than 50 ppm sodium, less than 15 ppm magnesium, less than 10 ppm aluminum, less than 8 ppm silicon, less than 4 ppm phosphorous, less than 3 ppm sulfur, less than 3 ppm chlorine, less than 2 ppm potassium, less than 3 ppm calcium, less than 2 ppm scandium, less than 1 ppm titanium, less than 1 ppm vanadium, less than 0.5 ppm chromium, less than 0.5 ppm manganese, less than 0.5 ppm iron, less than 0.25 ppm cobalt, less than 0.25 ppm nickel, less than 0.25 ppm copper, less than 0.5 ppm zinc, less than 0.5 ppm gallium, less than 0.5 ppm germanium, less than 0.5 ppm arsenic, less than 0.5 ppm selenium, less than 1 ppm bromine, less than 1 ppm rubidium, less than 1.5 ppm strontium, less than 2 ppm yttrium, less than 3 ppm zirconium, less than 2 ppm niobium, less than 4 ppm molybdenum, less than 4 ppm technetium, less than 7 ppm ruthenium, less than 6 ppm rhodium, less than 6 ppm palladium, less than 9 ppm silver, less than 6 ppm cadmium, less than 6 ppm indium, less than 5 ppm tin, less than 6 ppm antimony, less than 6 ppm tellurium, less than 5 ppm iodine, less than 4 ppm cesium, less than 4 ppm barium, less than 3 ppm lanthanum, less than 3 ppm cerium, less than 2 ppm praseodymium, less than 2 ppm, neodymium, less than 1.5 ppm promethium, less than 1 ppm samarium, less than 1 ppm europium, less than 1 ppm gadolinium, less than 1 ppm terbium, less than 1 ppm dysprosium, less than 1 ppm holmium, less than 1 ppm erbium, less than 1 ppm thulium, less than 1 ppm ytterbium, less than 1 ppm lutetium, less than 1 ppm hafnium, less than 1 ppm tantalum, less than 1 ppm tungsten, less than 1.5 ppm rhenium, less than 1 ppm osmium, less than 1 ppm iridium, less than 1 ppm platinum, less than 1 ppm gold, less than 1 ppm mercury, less than 1 ppm thallium, less than 1 ppm lead, less than 1.5 ppm bismuth, less than 2 ppm thorium, or less than 4 ppm uranium.

In some specific embodiments, the porous carbon material comprises less than 100 ppm sodium, less than 300 ppm silicon, less than 50 ppm sulfur, less than 100 ppm calcium, less than 20 ppm iron, less than 10 ppm nickel, less than 140 ppm copper, less than 5 ppm chromium and less than 5 ppm zinc as measured by proton induced x-ray emission. In other specific embodiments, the porous carbon material comprising less than 50 ppm sodium, less than 30 ppm sulfur, less than 100 ppm silicon, less than 50 ppm calcium, less than 10 ppm iron, less than 5 ppm nickel, less than 20 ppm copper, less than 2 ppm chromium and less than 2 ppm zinc.

In other specific embodiments, porous carbon material comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the porous carbon material comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In some embodiments, the porous carbon material comprising less than 10 ppm iron. In other embodiments, the porous carbon material comprises less than 3 ppm nickel. In other embodiments, the porous carbon material comprises less than 30 ppm sulfur. In other embodiments, the porous carbon material comprises less than 1 ppm chromium. In other embodiments, the porous carbon material comprises less than 1 ppm copper. In other embodiments, the carbon material comprises less than 1 ppm zinc.

In still other examples, porous carbon material comprises less than 100 ppm sodium, less than 100 ppm silicon, less than 10 ppm sulfur, less than 25 ppm calcium, less than 1 ppm iron, less than 2 ppm nickel, less than 1 ppm copper, less than 1 ppm chromium, less than 50 ppm magnesium, less than 10 ppm aluminum, less than 25 ppm phosphorous, less than 5 ppm chlorine, less than 25 ppm potassium, less than 2 ppm titanium, less than 2 ppm manganese, less than 0.5 ppm cobalt and less than 5 ppm zinc as measured by proton induced x-ray emission, and wherein all other elements having atomic numbers ranging from 11 to 92 are undetected by proton induced x-ray emission.

Additionally, the total ash content of the porous carbon material may, in some instances, have an effect on the electrochemical performance of the hydrated carbon material powder. Accordingly, in some embodiments, the ash content of the porous carbon material ranges from 0.1% to 0.001%, for example in some specific embodiments the ash content of the porous carbon material is less than 0.1%, less than 0.08%, less than 0.05%, less than 0.03%, less than 0.025%, less than 0.01%, less than 0.0075%, less than 0.005% or less than 0.001%.

In other embodiments, the porous carbon material comprises a total

PIXE impurity content of less than 500 ppm and an ash content of less than 0.08%. In further embodiments, the porous carbon material comprises a total PIXE impurity content of less than 300 ppm and an ash content of less than 0.05%. In other further embodiments, the porous carbon material comprises a total PIXE impurity content of less than 200 ppm and an ash content of less than 0.05%. In other further embodiments, the porous carbon material comprises a total PIXE impurity content of less than 200 ppm and an ash content of less than 0.025%. In other further embodiments, the porous carbon material comprises a total PIXE impurity content of less than 100 ppm and an ash content of less than 0.02%. In other further embodiments, the porous carbon material comprises a total PIXE impurity content of less than 50 ppm and an ash content of less than 0.01%.

In other embodiments, the porous carbon material comprises a total TXRF impurity content of less than 500 ppm and an ash content of less than 0.08%. In further embodiments, the porous carbon material comprises a total TXRF impurity content of less than 300 ppm and an ash content of less than 0.05%. In other further embodiments, the porous carbon material comprises a total TXRF impurity content of less than 200 ppm and an ash content of less than 0.05%. In other further embodiments, the porous carbon material comprises a total TXRF impurity content of less than 200 ppm and an ash content of less than 0.025%. In other further embodiments, the porous carbon material comprises a total TXRF impurity content of less than 100 ppm and an ash content of less than 0.02%. In other further embodiments, the porous carbon material comprises a total TXRF impurity content of less than 50 ppm and an ash content of less than 0.01%.

The hydrated carbon material powder may also comprise a high surface area. Accordingly, in some embodiments, the hydrated carbon material powder comprises a BET specific surface area greater than 50 m²/g, greater than 100 m²/g, greater than 150 m²/g, greater than 250 m²/g, greater than 300 m²/g, greater than 400 m²/g, greater than 500 m²/g, greater than 600 m²/g, greater than 700 m²/g, greater than 800 m²/g, greater than 900 m²/g, greater than 1000 m²/g, greater than 1,500 m²/g, greater than 2000 m²/g, greater than 2400 m²/g, greater than 2500 m²/g, greater than 2750 m²/g or greater than 3000 m²/g. In other embodiments, the BET specific surface area ranges from about 100 m²/g to about 3000 m²/g, for example, from about 500 m²/g to about 1000 m²/g, from about 1000 m²/g to about 1500 m²/g, from about 1500 m²/g to about 2000 m²/g, from about 2000 m²/g to about 2500 m²/g or from about 2500 m²/g to about 3000 m²/g. In certain specific embodiments, the porous carbon material has a BET specific surface area ranging from 500 m²/g to 3,000 m²/g. In other specific embodiments, the porous carbon material has a BET specific surface area ranging from 500 m²/g to 1,000 m²/g. In some embodiments, the porous carbon material has a BET specific surface area ranging from 1,000 m²/g to 2,000 m²/g.

In some embodiments, the porous carbon material has a BET specific surface area ranging from 1650 m²/g to 1750 m²/g. from 1600 m²/g to 1800 m²/g. or from 1400 m²/g to 2200 m²/g. In some embodiments, the porous carbon material has a BET specific surface area of about 1700 m²/g.

In some embodiments, the porous carbon material has a BET specific surface area ranging from 650 m²/g to 750 m²/g. from 600 m²/g to 800 m²/g. or from 400 m²/g to 1200 m²/g. In some embodiments, the porous carbon material has a BET specific surface area of about 700 m²/g.

One specific embodiment provides an isolated solid composition comprising a porous carbon material and water, wherein the composition comprises a volume of water greater than a total pore volume of the porous carbon material. In a related embodiment of the foregoing, the volume of water ranges from 10% to 99%, from 10 to 90%, from 10 to 80%, from 10 to 75%, from 10 to 70%, from 10 to 60%, from 30 to 50%, from 35 to 50%, from 45 to 65%, from 40 to 70%, from 65 to 75%, from 60 to 80%, from 55 to 85%, 10% to 50%, from 20% to 30%, from 40% to 50% 10% to 70%, from 10% to 65%, from 10% to 60%, from 12% to 57%, from 15% to 55%, from 17% to 52%, from 20% to 50%, from 22% to 50%, from 25% to 50%, from 27% to 50%, from 30% to 50%, from 32% to 50%, from 35% to 50% or from 37% to 55% greater than the total pore volume.

In a related embodiment of the foregoing, the volume of water ranges from 10% to 200%, from 10 to 190%, from 10 to 180%, from 10 to 175%, from 10 to 170%, from 10 to 160%, from 30 to 150%, from 35 to 150%, from 45 to 165%, from 40 to 170%, from 65 to 175%, from 60 to 180%, from 55 to 185%, 10% to 150%, from 20% to 130%, from 40% to 150% 10% to 170%, from 10% to 165%, from 10% to 160%, from 12% to 157%, from 15% to 155%, from 17% to 152%, from 20% to 150%, from 122% to 50%, from 125% to 150%, from 27% to 150%, from 30% to 150%, from 32% to 150%, from 35% to 150% or from 37% to 155% greater than the total pore volume.

In another embodiment of the foregoing, the total pore volume ranges from 0.3 cc/g to 1.5 cc/g, from 0.3 cc/g to 0.7 cc/g, from 0.3 cc/g to 0.8 cc/g or from 1.0 cc/g to 1.5 cc/g based on weight of the porous carbon material in the absence of the water.

The necessary water to carbon ratio can be calculated based on the total pore volume and a pore characteristic dependent factor known as an “excess water factor” or “EWF” according to the following equation (Equation 1):

$$Water \text{:} Carbon Material = {\sum }_{i = 1}^{n} [ Excess Water {Factor}_{i} ( \frac{Pore {Volume}_{i}}{Total Pore Volume} ) ] \times Total Pore Volume$$

where i denotes a binned pore characteristic (e.g., pores ranging in diameter from 0 to 20 angstroms, pores ranging in diameter from 20 to 300 angstroms, etc.) representing a fraction of the total pore volume and n is the number of bins that necessarily comprise the total pore volume. “Pore Volume,” is the pore volume residing in the relevant binned characteristic, i. Without wishing to be bound by theory, it appears that a porous carbon material having larger pore diameters require a greater relative volume of excess water.

For example, the excess water factor of a microporous, mesoporous or a carbon material having a combination of micro- and mesopores is calculated using the following equation (i.e., Equation 1 modified to calculate an EWF for carbon materials having meso- and micropores):

EWF=(% PV_{micro}×EWF_{micro})+(% PVₘₑₛₒ×EWFₘₑₛₒ)

wherein EWF is the excess water factor, % PV_{micro} is the percentage of the total pore volume residing in micropores, EWF_{micro} is the EWF for micropores (i.e., 1.39), % PVₘₑₛₒ is the percentage of the total pore volume residing in mesopores, and EWFₘₑₛₒ is the EWF for mesopores (i.e., 1.7).

Certain embodiments provide a porous carbon material (e.g., mesoporous carbon material) having an excess water factor of 1.7. In some embodiments, the porous carbon material has an excess water factor between 1.65 and 1.75, between 1.60 and 1.80, between 1.50 and 1.90, between 1.20 and 2.20, or above 0.9.

In certain embodiments, the porous carbon material is a microporous/mesoporous mixed carbon material having an excess water factor of 1.55, an excess water factor between 1.50 and 1.60, between 1.40 and 1.70, between 1.20 and 1.90, between 1.00 and 2.10, or above 0.5.

In certain embodiments, the porous carbon material is a microporous carbon material having an excess water factor of about 1.39, between 1.30 and 1.50, between 1.20 and 1.60, between 1.00 and 1.80, between 0.75 and 2.00, or above 0.5. Embodiments describing an excess water factor may be combined with any of the foregoing embodiments describing pore diameter or pore volume distributions.

The excess water factor as described above is not particularly limiting and can be adjusted and extrapolated to more varied pore structures (e.g., carbon materials having macropores, combination of meso-, micro-, or macropores).

2. Devices

The disclosed hydrated carbon material powder can be used as electrode material in any number of electrical energy storage and distribution devices. One such device is an ultracapacitor. Ultracapacitors comprising carbon materials are described in detail in co-owned U.S. Pat. No. 7,835,136 which is hereby incorporated by reference in its entirety.

Accordingly, certain embodiments provide a use of the hydrated carbon material powder in preparing a device, for example, wherein the device is an ultracapacitor. In one embodiment, the ultracapacitor device comprises a gravimetric power of at least 5 W/g, at least 10 W/g, at least 15 W/g, at least 20 W/g, at least 25 W/g, at least 30 W/g, at least 35 W/g, at least 50 W/g.

In another embodiment, the ultracapacitor device comprises a volumetric power of at least 2 W/g, at least 4 W/cc, at least 5 W/cc, at least 10 W/cc, at least 15 W/cc or at least 20 W/cc. In another embodiment, the ultracapacitor device comprises a gravimetric energy of at least 2.5 Wh/kg, at least 5.0 Wh/kg, at least 7.5 Wh/kg, at least 10 Wh/kg, at least 12.5 Wh/kg, at least 15.0 Wh/kg, at least 17.5. Wh/kg, at least 20.0 Wh/kg, at least 22.5 Wh/kg or at least 25.0 Wh/kg. In another embodiment, the ultracapacitor device comprises a volumetric energy of at least 1.5 Wh/liter, at least 3.0 Wh/liter, at least 5.0 Wh/liter, at least 7.5 Wh/liter, at least 10.0 Wh/liter, at least 12.5 Wh/liter, at least 15 Wh/liter, at least 17.5 Wh/liter or at least 20.0 Wh/liter.

In some embodiments of the foregoing, the gravimetric power, volumetric power, gravimetric energy and volumetric energy of an ultracapacitor device are measured by constant current discharge from 2.7 V to 1.89 V employing a 1.0 M solution of tetraethylammonium-tetrafluroroborate in acetonitrile (1.0 M TEATFB in AN) electrolyte and a 0.5 second time constant.

In one embodiment, the ultracapacitor device comprises a gravimetric power of at least 10 W/g, a volumetric power of at least 5 W/cc, a gravimetric capacitance of at least 100 F/g (@0.5 A/g) and a volumetric capacitance of at least 10 F/cc (@0.5 A/g). In one embodiment, the aforementioned ultracapacitor device is a coin cell double layer ultracapacitor comprising the hydrated carbon material powder, a conductivity enhancer, a binder, an electrolyte solvent, and an electrolyte salt. In further embodiments, the aforementioned conductivity enhancer is a carbon black and/or other conductivity enhancer known in the art. In further embodiments, the aforementioned binder is Teflon and or other binder known in the art. In further aforementioned embodiments, the electrolyte solvent is acetonitrile or propylene carbonate, or other electrolyte solvent(s) known in the art. In further aforementioned embodiments, the electrolyte salt is tetraethylaminotetrafluroborate or triethylmethyl aminotetrafluroborate or other electrolyte salt known in the art, or liquid electrolyte known in the art.

In one embodiment, an ultracapacitor device comprises a gravimetric power of at least 15 W/g, a volumetric power of at least 10 W/cc, a gravimetric capacitance of at least 110 F/g (@0.5 A/g) and a volumetric capacitance of at least 15 F/cc (@0.5 A/g). In one embodiment, the aforementioned ultracapacitor device is a coin cell double layer ultracapacitor comprising the hydrated carbon material powder, a conductivity enhancer, a binder, an electrolyte solvent, and an electrolyte salt. In further embodiments, the aforementioned conductivity enhancer is a carbon black and/or other conductivity enhancer known in the art. In further embodiments, the aforementioned binder is Teflon and or other binder known in the art. In further aforementioned embodiments, the electrolyte solvent is acetonitrile or propylene carbonate, or other electrolyte solvent(s) known in the art. In further aforementioned embodiments, the electrolyte salt is tetraethylaminotetrafluroborate or triethylmethyl aminotetrafluroborate or other electrolyte salt known in the art, or liquid electrolyte known in the art.

In some of the foregoing embodiments, the ultracapacitor device comprises a gravimetric power of at least 25 W/g, a volumetric power of at least 10.0 W/cc, a gravimetric energy of at least 5.0 Wh/kg and a volumetric energy of at least 3.0 Wh/L.

In another of the foregoing embodiments, the ultracapacitor device comprises a gravimetric power of at least 15 W/g, a volumetric power of at least 10.0 W/cc, a gravimetric energy of at least 20.0 Wh/kg and a volumetric energy of at least 12.5 Wh/L.

In one of the foregoing embodiments, the ultracapacitor device comprises a gravimetric capacitance of at least 15 F/g, at least 20 F/g, at least 25 F/g, at least 30 F/g, at least 35 F/g, at least 90 F/g, at least 95 F/g, at least 100 F/g, at least 105 F/g, at least 110 F/g, at least 115 F/g, at least 120 F/g, at least 125 F/g or at least 130 F/g. In another embodiment, the ultracapacitor device comprises a volumetric capacitance of at least 5 F/cc, at least 10 F/cc, at least 15 F/cc, at least 18 F/cc, at least 20 F/cc or at least 25 F/cc. In some embodiments of the foregoing, the gravimetric capacitance and volumetric capacitance are measured by constant current discharge from 2.7 V to 0.1 V with a 5-second time constant and employing a 1.8 M solution of tetraethylammonium-tetrafluroroborate in acetonitrile (1.8 M TEATFB in AN) electrolyte and a current density of 0.5 A/g, 1.0 A/g, 4.0 A/g or 8.0 A/g.

In some of the foregoing embodiments provide ultracapacitors as disclosed herein, wherein a percent decrease in original capacitance (i.e., capacitance before being subjected to voltage hold) of the ultracapacitor after a voltage hold period is less than the percent decrease in original capacitance of an ultracapacitor comprising known carbon materials. In one embodiment, the percent of original capacitance remaining for an ultracapacitor after a voltage hold at 2.7 V for 24 hours at 65 ° C. is at least 90%, at least 80%, at least 70%, at least 60%, at least 50%, at least 40%, at least 30%, at least 20% or at least 10%. In further embodiments of the foregoing, the percent of original capacitance remaining after the voltage hold period is measured at a current density of 0.5 A/g, 1 A/g, 4 A/g or 8 A/g.

In another embodiment, the present disclosure provides ultracapacitors as disclosed herein, wherein the percent decrease in original capacitance of the ultracapacitor after repeated voltage cycling is less than the percent decrease in original capacitance of an ultracapacitor comprising known carbon materials subjected to the same conditions. For example, in one embodiment, the percent of original capacitance remaining for an ultracapacitor is more than the percent of original capacitance remaining for an ultracapacitor comprising known carbon materials after 1000, 2000, 4000, 6000, 8000, or 10,000 voltage cycling events comprising cycling between 2 V and 1 V at a current density of 4 A/g. In another embodiment, the percent of original capacitance remaining for an ultracapacitor after 1000, 2000, 4000, 6000, 8000, or 10,000 voltage cycling events comprising cycling between 2 V and 1 V at a current density of 4 A/g, is at least 90%, at least 80%, at least 70%, at least 60%, at least 50%, at least 40%, at least 30%, at least 20% or at least 10%.

As noted above, the hydrated carbon material powder can be used for preparing ultracapacitor devices. In some embodiments, the hydrated carbon material powder or porous carbon material is milled to an average particle size of about 10 microns using a jetmill according to the art.

The disclosed hydrated carbon material powder can be used in devices requiring stable, high surface area micro- and mesoporous structure. Examples of applications for the disclosed hydrated carbon material powder include, but are not limited to: energy storage and distribution devices, capacitor electrodes, ultracapacitor electrodes, pseudocapacitor electrodes, battery electrodes, lithium ion anodes, lithium ion cathodes, lithium-carbon capacitor electrodes, lead acid battery electrodes, gas diffusion electrodes, including lithium-air electrodes and zinc-air electrodes, lithium ion batteries and capacitors (for example as cathode material), conducting current collectors/scaffolds for other active materials in electrochemical systems, nanostructured material support scaffolds, solid state gas storage (e.g., H₂ and CH₄ storage), adsorbents and as a carbon-based scaffold support structure for other catalytic functions such as hydrogen storage or fuel cell electrodes.

The disclosed hydrated carbon material powder may also be employed in kinetic energy harvesting applications such as: hybrid electric vehicles, heavy hybrids, all electric drive vehicles, cranes, forklifts, elevators, electric rail, hybrid locomotives and electric bicycles. The hydrated carbon material powder may also be employed in electrical back-up applications such as: UPS, data center bridge power, voltage dip compensation, electric brake actuators, electric door actuators, electronics, telecom tower bridge power. Applications requiring pulse power in which the hydrated carbon material powder of this disclosure may be useful include, but are not limited to: boardnet stabilization, electronics including cell phones, PDAs, camera flashes, electronic toys, wind turbine blade pitch actuators, power quality/power conditioning/frequency regulation, and electric supercharger. Yet other uses of the hydrated carbon material powder includes use in automotive starting and stopping systems, power tools, flashlights, personal electronics, self-contained solar powered lighting systems, RFID chips and systems, wind-field developers for survey device power, sensors, pulse laser systems and phasers.

The hydrated carbon material powder disclosed herein finds utility in any number of electronic devices including wireless consumer and commercial devices such as digital still cameras, notebook PCs, medical devices, location tracking devices, automotive devices, compact flash devices, mobiles phones, PCMCIA cards, handheld devices, and digital music players.

One embodiment provides use of the hydrated carbon material powder according to the foregoing embodiments, wherein the electrical energy storage device is an electric double layer capacitor (EDLC) device comprising:

a. a positive electrode and a negative electrode, wherein each of the positive and negative electrode comprise the hydrated carbon;

b. an inert porous separator; and

c. an electrolyte;

wherein the positive electrode and the negative electrode are separated by the inert porous separator.

In related embodiments, the EDLC device comprises a gravimetric capacitance of at least of at least 13 F/cc as measured by constant current discharge from 2.7 V to 0.1 V and with at least 0.24 Hz frequency response and employing a 1.8 M solution of tetraethylammonium-tetrafluroroborate in acetonitrile electrolyte and a current density of 0.5 A/g. In other embodiments, the EDLC device comprises a gravimetric capacitance of at least of at least 17 F/cc as measured by constant current discharge from 2.7 V to 0.1 V and with at least 0.24 Hz frequency response and employing a 1.8 M solution of tetraethylammonium-tetrafluroroborate in acetonitrile electrolyte and a current density of 0.5 A/g. In certain other related embodiments, the EDLC device comprises a volumetric capacitance of at least of 20 F/cc as measured by constant current discharge from 2.7 V to 0.1 V with a 5 second time constant employing a 1.8 M solution of tetraethylammonium-tetrafluroroborate in acetonitrile electrolyte and a current density of 0.5 A/g. In some of the foregoing embodiments, the EDLC device comprises a gravimetric capacitance of at least of 25 F/g as measured by constant current discharge from 2.7 V to 0.1 V with a 5 second time constant employing a 1.8 M solution of tetraethylammonium-tetrafluroroborate in acetonitrile electrolyte and a current density of 0.5 A/g.

In still other embodiments, the EDLC device comprises a gravimetric capacitance of 104 F/g or greater as measured by constant current discharge from 2.7 V to 0.1 V with a 5 second time constant employing a 1.8 M solution of tetraethylammonium-tetrafluoroborate in acetonitrile electrolyte and a current density of 0.5 A/g. In other embodiments, the EDLC device comprises a volumetric capacitance of 5.0 F/cc or greater as measured by constant current discharge from 2.7 V to 0.1 V with a 5 second time constant employing a 1.8 M solution of tetraethylammonium-tetrafluoroborate in acetonitrile electrolyte and a current density of 0.5 A/g. In some other embodiments of the foregoing, the volumetric capacitance is 10.0 F/cc or greater, 15.0 F/cc or greater, 20.0 F/cc or greater, 21.0 F/cc or greater, 22.0 F/cc or greater or 23.0 F/cc or greater.

The carbon electrodes (i.e., comprising hydrated carbon material powder) of the disclosed EDLCs may be wetted with an appropriate electrolyte solution. Examples of solvents for use in electrolyte solutions for the devices of the present disclosure include but are not limited to propylene carbonate, ethylene carbonate, butylene carbonate, dimethyl carbonate, methyl ethyl carbonate, diethyl carbonate, sulfolane, methylsulfolane and acetonitrile. Such solvents are generally mixed with solute, including, tetralkylammonium salts such as TEATFB (tetraethylammonium tetrafluoroborate); TEMATFB (tri-ethyl,methylammonium tetrafluoroborate); EMITFB (1-ethyl-3-methylimidazolium tetrafluoroborate), tetramethylammonium or triethylammonium based salts. The electrolyte can be a water-based acid or base electrolyte such as mild sulfuric acid or potassium hydroxide.

Accordingly, in some embodiments, the electrodes of the EDLC are wetted with a 1.0 M solution of tetraethylammonium-tetrafluroroborate in acetonitrile (1.0 M TEATFB in AN) electrolyte. In other embodiments, the electrodes of the EDLC are wetted with a 1.0 M solution of tetraethylammonium-tetrafluroroborate in propylene carbonate (1.0 M TEATFB in PC) electrolyte. These are common electrolytes used in both research and industry and are considered standards for assessing device performance.

Methods for determining capacitance and power output are described in U.S. Pub. No. 2012/0202033, which is hereby incorporated by reference in its entirety.

3. Methods

One embodiment provides a method for preparing a hydrated carbon material powder, the method comprising:

contacting a porous carbon material having a pore volume with a first volume of water greater than the pore volume, thereby substantially filling the pore volume with water;

removing a portion of the first volume of water; and

isolating the hydrated carbon material in powder form,

wherein the hydrated carbon material powder comprises a second volume of water greater than the pore volume.

In related embodiments of the foregoing method, the hydrated carbon material powder is defined as according to the embodiments described herein above.

One embodiment provides a method for preparing a negative active material for a lead acid battery, the method comprising admixing the hydrated carbon material powder of any one the foregoing embodiments, or the isolated solid composition of any one foregoing methods, with lead, water and sulfuric acid, thereby forming a paste.

Active materials within the scope of the present disclosure include materials capable of storing and/or conducting electricity. The active material can be any active material known in the art and useful in lead acid batteries, for example the active material may comprise lead, lead (II) oxide, lead (IV) oxide, or combinations thereof and may be in the form of a paste.

Some embodiments provide a lead acid battery comprising the hydrated carbon material powder. For example, some embodiments provide a cell comprising at least one positive electrode comprising positive active material, at least one negative electrode comprising the hydrated carbon material powder according to any one the foregoing embodiments, wherein the positive electrode and the negative electrode are separated by an inert porous separator. In some embodiments, the lead acid battery is a 2V lead acid battery. In some embodiments, the cell has an operating voltage of about 2 volts.

One embodiment provides use of the hydrated carbon material powder of any one of the foregoing embodiments, or the isolated solid composition of any one of the embodiments of the methods described herein, for preparation of an electrode for an electrical storage device. In an embodiment of the foregoing, the electrical energy storage device is a battery, for example, a lead acid battery.

The disclosed hydrated carbon material powder also find utility as electrodes in a number of types of batteries. One such battery is the metal air battery, for example lithium air batteries. Lithium air batteries generally comprise an electrolyte interposed between positive electrode and negative electrodes. The positive electrode generally comprises a lithium compound such as lithium oxide or lithium peroxide and serves to oxidize or reduce oxygen. The negative electrode generally comprises a carbonaceous substance which absorbs and releases lithium ions. As with supercapacitors, batteries such as lithium air batteries which comprise the disclosed hydrated carbon material powder are expected to be superior to batteries comprising known carbon materials.

Any number of other batteries, for example, zinc-carbon batteries, lithium/carbon batteries, lead acid batteries and the like are also expected to perform better with the carbon materials. One skilled in the art will recognize other specific types of carbon containing batteries which will benefit from the disclosed hydrated carbon material powder.

In another embodiment related to the foregoing embodiments, the electrical energy storage device is an electric double layer capacitor (EDLC) device comprising:

a. a positive electrode and a negative electrode, wherein each of the positive and negative electrode comprise the hydrated carbon;

b. an inert porous separator; and

c. an electrolyte;

wherein the positive electrode and the negative electrode are separated by the inert porous separator.

Methods of mixing can vary and are known in the art. For example, methods of mixing can include, for example, use of different mixing apparatuses (e.g., ROSS planetary mixer, a “Thinky” planetary mixer, etc.), water injection methods (e.g., as a vapor or liquid), and mixing blades and/or shafts. Additionally, different discharge methods can be used to facilitate the extraction process. Minor adjustments can be made to the conditions related to the preparation of hydrated carbon material powder, including applying a partial vacuum to induce higher water absorption.

Accordingly, in some embodiments, the volume of water is injected as a vapor during mixing. In some other embodiments, a partial vacuum is applied during the mixing.

4. Properties of the Disclosed Hydrated Carbon Material Powder

Embodiments disclosed herein improve carbon dispersion quality, facilitate ease of handling, and avoid “dusting” or releasing potentially harmful particulate into the air. The present disclosure provides embodiments that maintain free-flowing powder characteristics while saving the time and resources associated with hydrating (or “wetting”) carbon materials, especially carbon materials with irregular porosity.

The superior dispersion of embodiments of the hydrated carbon material powder disclosed herein provides more uniform and rapid mixing with other additives when in slurry. As such, embodiments of the present disclosure provide more comprehensive and uniform mixing of carbon material with other materials, resulting in higher quality products (e.g., batteries, electrodes, EDLC devices, etc.).

For example, for incorporating carbon additives in lead acid negative active materials (NAM). Embodiments of the present disclosure avoid leaching water when mixed into a lead paste with other dry ingredients, water and sulfuric acid. As a result, embodiments of the present disclosure avoid the occurrence of dry sports in cured lead acid plates, which could damage the integrity of the same.

### EXAMPLES

The carbon materials disclosed in the following Examples and in certain embodiments were prepared according to methods known in the art. For example, the carbon materials can be prepared according to the methods disclosed in U.S. Pub. No. 2012/0202033, 2011/0002086, the entirety of which is incorporated herein by reference.

### Example 1

### Small Scale Preparation of Hydrated Carbon Material Powder

In four separate batches, 10 g of Carbon 1, Carbon 2, Carbon 3, and Carbon 4 powder were added to a “Thinky” planetary overhead mixer. Incremental additions of de-ionized water were added during mixing in order to determine the amount of water required to hydrate each sample. It was determined that the required water content increased in direct proportion to the pore volume of the porous carbon material. The results are shown in Table 1 below, along with the physical characteristics of each carbon material.

TABLE 1
Physical Properties of Hydrated Carbon Material Powder

| | | | | | Water | Total | Total | Excess |
|---|---|---|---|---|---|---|---|---|
| | SSA | PV | Particle | | Content | PV | Water | Water† |
| Sample | (m²/g) | (cc/g) | Size | | (% w/w) | (mL) | (mL) | (%) |
| Carbon 1 | 1748 | 1.29 | 8.5 | μm | 67 | 12.9 | 20 | 55^{#} (42) |
| Carbon 2 | 1711 | 1.29 | 60 | μm | 67 | 12.9 | 20 | 55 (42) |
| Carbon 3 | 675 | 0.53 | 60 | μm | 47 | 5.3 | 9 | 70 (27) |
| Carbon 4 | 1709 | 0.72 | 8.5 | μm | 50 | 7.2 | 10 | 39 (22) |

†Excess water relative to the pore volume calculated using Equation 2 (values in parentheses)
^{#}Percentages were calculated using excess water factor calculations of Equation 1

Additionally, Carbons 1, 2, 3, and 4 had a pH value calculated to be 8.5, 7.5, 7.0, and 8.5, respectively. The dominant pore characteristics for Carbons 1, 2, 3, and 4 were micro/mesoporous, micro/mesoporous, mesoporous, and microporous, respectively. The ratio of excess water has a correlation with the pore characteristics (i.e., micro- or mesoporosity) of the porous carbon material. As noted above, Carbon 1 and Carbon 2 have both micro- and mesopores, Carbon 3 has only mesopores, and Carbon 4 has only micropores. The data from Table 1 were used to derive a version of Equation 1 for calculating the water content of the final hydrated carbon material powder. The necessary water to carbon ratio can be calculated based on Equation 1 for meso- and micropores, the total pore volume, and a pore characteristic dependent factor known as an “excess water factor” or “EWF” (i.e., when Equation 1 adapted for calculation for carbon material having meso- and micropores):

EWF=(% PV_{micro}×EWF_{micro})+PVₘₑₛₒ×EWFₘₑₛₒ)

wherein EWF is the excess water factor, % PV_{micro} is the percentage of the total pore volume residing in micropores, EWF_{micro} is the EWF for micropores (i.e., 1.39), % PVₘₑₛₒ is the percentage of the total pore volume residing in mesopores, and EWFₘₑₛₒ is the EWF for mesopores (i.e., 1.7).

These data show that the volume of water needed to hydrate each batch of porous carbon material was unexpectedly greater than the pore volume of the porous carbon material. That is, a volume of water greater than the total pore volume of the porous carbon material yields hydrated carbon material powder that remains in free-flowing powder form.

These data from Table 1 were used to derive an equation for calculating the water content of the final hydrated carbon material powder. A calculation can be made using an EWF for mesopores (EWFₘₑₛₒ)=1.7 and an excess water factor for micropores (EWF_{micro})=1.39 (PV=pore volume in the calculations below). That is, the water to carbon material is calculated according to the following:

Water:Carbon Material=(% micropore volume×EWF_{micro}+% mesopore volume×EWFₘₑₛₒ)×(Total PV)

Calculation for Carbon 1 (water to carbon ratio of 2.0 mL/g)

[(50% mesoporosity)(1.7)+(50% microporosity)(1.39)]×1.29=2.0 mL/g

Calculation for Carbon 3 (water to carbon ratio of 0.9 mL/g)

[(100% mesoporosity)(1.7)]×0.53=0.9 mL/g

Calculation for Carbon 4 (water to carbon ratio of 1.0 mL/g)

[(100% microporosity)(1.39)]×0.72=1.0 mL/g

Alternatively, the water content can be calculated based on the pore volume and excess water according to the following equation (Equation 2):

$$Water \text{:} Carbon Material = \frac{[ ( Excess Water ) ( 1 - PV ) ] + PV}{1 - ( Excess Water )}$$

Additionally, the ratio of excess water appears to have a correlation with the pore characteristics of the porous carbon material. Carbon 1 and Carbon 2 contain both micropores and mesopores, but Carbon 3 contains only mesopores. Without wishing to be bound by theory, it appears that micropores are hydrated through capillary action at a higher rate compared to mesopores. Thus, hydrated carbon material powders with micropores have a higher water content compared to hydrated carbon material powder with only mesopores when carbon material is mixed with water across the same time period. The ranges of predicted hydration ratios based on pore structure are shown in Table 2 below. Equation 1 is the preferred method for calculating excess water (i.e., using excess water factor).

TABLE 2
Expected Hydration Ratios Based on Porosity

| Porosity | Range of Water Ratio† | Range of Water Ratio^{#} |
|---|---|---|
| micro- only | — | 130-150% |
| micro- and meso- | 130-150% | 140-160% |
| Meso-only | 110-130% | 160-180% |

†Calculated based on a pore volume as 100% (Equation 2)
^{#}calculated using Equation 1

### Example 2

### Pilot Scale Preparation of Hydrated Carbon Material Powder

Carbon 1 and Carbon 2 powder (1 kg) were added to a ROSS planetary mixer. Water was added and mixed with the porous carbon material to adequately hydrate the porous carbon material resulting in hydrated carbon material powder.

Water content of the final hydrated carbon material powder was calculated using the equation shown in Example 1. The actual water content was determined by sampling the hydrated carbon material powder of Carbon 1 and Carbon 2 and drying each sample in a convection oven at 100 ° C. for 12 hours. The actual water content for hydrated carbon material powder of Carbon 1 and Carbon 2 were 59% and 46% w/w, respectively.

### Example 3

### Uniformity Test

Additional samples of Carbon 2 were taken from the mixture of Example 2 to determine the uniformity of the final hydrated carbon material powder. Samples were collected from different positions of the bulk material as indicated in Table 3, below. The water content was determined for each of the samples according to the procedure described in Example 2. The data of Table 3 show that the overall mixture showed highly uniform water content throughout.

TABLE 3
Uniformity Measurements of
Hydrated Carbon Material Powder

| | Water Content† |
|---|---|
| Position | (% w/w) |
| Bottom | 45.6 |
| Bottom | 45.8 |
| Top | 45.9 |
| Top | 46.0 |
| Corner-right | 45.5 |
| Corner-right | 45.9 |
| Corner-right | 45.6 |
| Corner-left | 45.6 |
| Corner-left | 45.7 |
| Corner-left | 45.8 |

†Standard deviation = 0.4%

### Example 4

### Electrochemical Performance—Dry vs. Hydrated Carbon

Two paste compositions to produce negative active materials or NAMs (i.e., NAM 1 and NAM 2) were prepared to determine the effect of adding hydrated carbon into a lead acid paste during processing. NAM components were added according to Table 4, below:

TABLE 4
Components of lead acid pastes

| | NAM 1 | | NAM 2 | |
|---|---|---|---|---|
| | | wt % | | wt % |
| | | (excluding | | (excluding |
| | Mass | water and | Mass | water and |
| Component | (g) | sulfuric acid) | (g) | sulfuric acid) |
| Leady Oxide | 1000 | — | 1000 | — |
| BaSO₄ | 6 | 0.6 | 6 | 0.6 |
| Lignin | 2 | 0.2 | 2 | 0.2 |
| N220 Carbon | 1 | 0.1 | 1 | 0.1 |
| Black | | | | |
| Dry Carbon 3 | 10 | 1.0 | — | — |
| Hydrated | — | — | 17.8^{†} | 1.78 |
| Carbon 3 | | | | |
| Water | 140 mL | | 132 mL + | |
| | | | 8 mL | |

| | | |
|---|---|---|
| Sulfuric Acid | 78 mL | 78 mL |

^{†}Hydrated Carbon 3 has a moisture content of 43.8% so an addition of 17.8 g introduced 10 g of carbon material and 8 mL of water.

To begin paste processing, the water volume was added to an Eirich EL1 mixing bucket. Barium sulfate, lignin, N220 carbon black and Carbon 3 (either hydrated or dry) was added to the water and mixed for 60 seconds by hand with a spatula. The leady oxide is then added to the mixture and the resultant mixture is mixed at a high intensity for 100 seconds. The acid is then added to the mixture during active mixing over a 12 minute period. The paste is mixed for an additional 2 minutes upon the completion of the addition of the acid. The resultant paste is applied to lead grids and cured to produce negative electrodes.

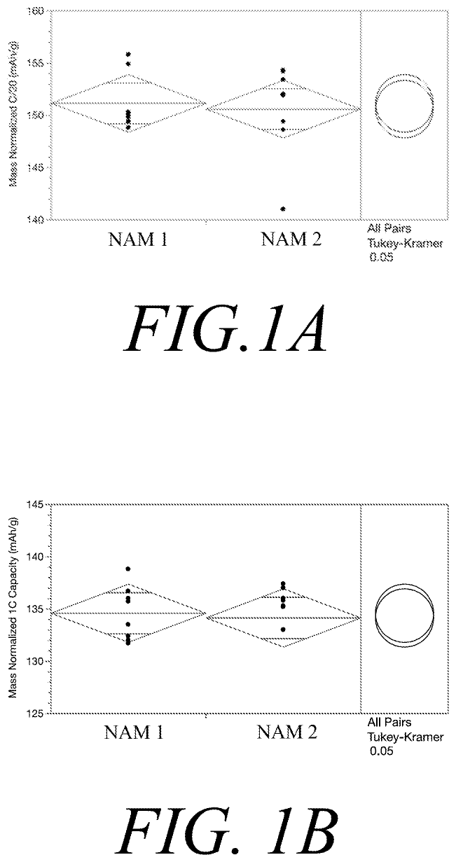

Lead acid cells prepared using NAM 1 and NAM 2 showed no significant difference in capacity when tested for C/20 and 1C capacity as shown in FIGS. 1A and 1B, respectively.

### Example 5

### Motive Power Recharge Times

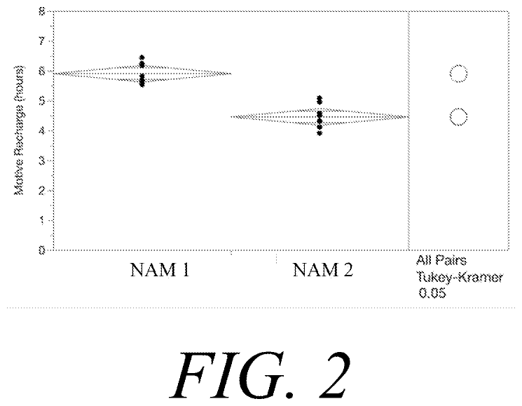

A Motive Power Test was used to determine the reduction in average charge times for NAMs prepared with hydrated carbons. That is, cells prepared with the NAM 1 and NAM 2 as described in Example 4 were tested to determine motive recharge times. The Motive Power Test used a discharge at 0.1 A (C/20) to 20% state of charge, a 1 minute rest, a charge at 2.6 V with a 0.8 A limit until reaching 105% of discharge capacity, followed by a 1 hour rest. The cell prepared with NAM 2 showed greatly decreased average charge times (e.g., 4.5 hours compared to 6 hours) as shown in FIG. 2 (theoretical minimum of 2.5 hours). That is, about a 43% improvement was observed for cells prepared with NAM 2.

### Example 6

### Micro-Cycling—Cycles Until 1^{st} Failure

A Micro-cycling/Time Varied High Rate Partial State of Charge testing protocol was used to test cells prepared using NAM 1 and NAM 2 as described in Example 4. The Micro-cycling test used the following steps:

1. discharge at 1 A (1 C) to 50% state of charge

2. 1 minute rest

3. a discharge at 2 A for 60 seconds

4. 10 second rest

5. charge at 2.4V until reaching 0.0333 Ah (i.e., the same as the discharge Ah)

6. 10 second rest

7. repeat steps 4-7 until 1.7V is reached (i.e., 1^{st} failure)

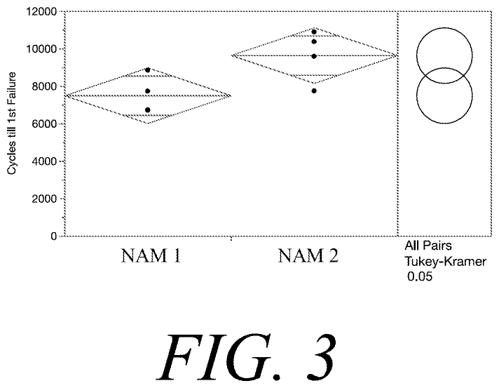

The results of the Micro-cycling testing protocol are shown in FIG. 3. In summary, an average improvement of 33% was observed for cells prepared with NAM 2 compared to cells prepared using NAM 1. That is, the average number of cycles before failure improved from 7,500 for cells prepared with NAM 1 compared to 10,000 for cells prepared with NAM 2.

### Example 7

### Scale Up Studies

9 batches were prepared using Carbon 3 material in a Littleford mixer, each batch had 20 kg of Carbon 3 material mixed with 18 kg of deionized water. Mixing was continued constantly for 25 minutes (at 38 RPM) with water added at 1400 mL/minute via injection over 13 minutes and a total mixing time of 25 minutes. The hydrated carbon material powder was collected using a discharge of 60-160 RPM to yield the following moisture contents listed in Table 5, below:

TABLE 5
Moisture content of hydrated carbon material powder

| Batch Number | Moisture Content (%) |
|---|---|
| 1 | 47.27 |
| 2 | 47.24 |
| 3 | 45.7 |
| 4 | 45.89 |
| 5 | 47.42 |
| 6 | 47.34 |
| 7 | 46.58 |
| 8 | 46.93 |
| 9 | 46.46 |

### Example 8

### Qualitative Slurry Analysis

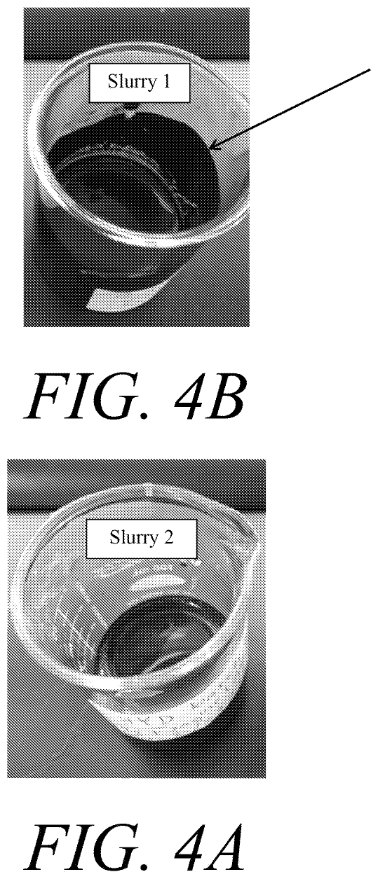

Two slurries were prepared, one with dry Carbon 3 (Slurry 1) and one with hydrated Carbon 3 (Slurry 2). The slurries were allowed to sit for 24 hours before analysis. Samples were agitated by gentle tilting and it was observed that Slurry 1 remained stuck to the wall (i.e., no longer in suspension; indicated with the arrow in FIG. 4A) of the beaker while Slurry 2 remained in suspension (FIG. 4B). It is highly desirable for carbon material to remain in suspension for ease of handling and to reduce loss of material during manufacturing process.

### Example 9

### Manufacture of Hydrated Carbon

Exemplary hydrated carbon of the present disclosure can be prepared on a relatively small (1 kg) to a relatively large scale (25 kg). A Lodige 5 L mixer was charged with 1 kg of dry Carbon 3 and fed deionized water at a rate of 40 mL/minutes to reach a solid: solvent ratio of 1:0.9. The resultant mixture was mixed at 150 RPM for 23 minutes. The moisture content of the resultant hydrated carbon material power was determined to be 47% by placing a 50 g at 100 ° C. in a convection oven overnight.

### Example 10

### Manufacture of Hydrated Carbon

Two other representative batches were prepared using a Littleford 130 L mixer. Batches were prepared according to the parameters described in Table 6, below:

TABLE 6
Batch parameters for large scale

| | Carbon 3 | | DI | | |
|---|---|---|---|---|---|
| | (1:0.9 | Mix | water feed | Discharge | Mixing |
| Batch | solid: | Speed | rate | Rate | Time |
| Number | solvent) | (RPM) | (mL/min.) | (Hz) | (minutes) |
| 1 | 25 kg | 156 (2.6 Hz) | 350 | 1.9 | 70 |
| 2 | 20 kg | 156 (2.6 Hz) | 350 | 1.9 | 55 |

### Example 11

### Comparison of Particle Size

Carbon 1 (particle size: about 8.5 microns) and Carbon 2 (particle size: about 60 microns) were hydrated according to Example 1 using different solid to solvent ratios. The resulting moisture contents were tested and the results are shown in Table 7, below:

TABLE 7
Moisture content for Carbon 1 and Carbon 2 hydrated
with different solid to solvent ratios

| | Solid to Solvent | Moisture Content |
|---|---|---|
| Carbon | Ratio | (%) |
| Carbon 1 | 1:1 | 48 |
| Carbon 1 | 1:1.5 | 58 |
| Carbon 1 | 1:2 | 64 |
| Carbon 2 | 1:1 | 48 |
| Carbon 2 | 1:1.5 | 60 |
| Carbon 2 | 1:2 | 68 |

U.S. Provisional Application 62/561,081, filed Sep. 20, 2017 is incorporated herein by reference, in its entirety.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A hydrated carbon material powder comprising:
a porous carbon material having a pore volume; and
a volume of water greater than the pore volume.

2. The hydrated carbon material powder of claim 1, wherein the hydrated carbon material powder comprises activated carbon.

3. The hydrated carbon material powder of any one of claim 1 or 2, wherein the hydrated carbon material powder has a water content ranging from 30% to 70% based on total weight of the hydrated carbon material powder.

4. The hydrated carbon material powder of any one of claims 1-3, wherein the hydrated carbon material powder has a water content greater than 40% based on total weight of the hydrated carbon material powder.

5. The hydrated carbon material powder of any one of claims 1-3, wherein the hydrated carbon material powder has a water content greater than 50% based on total weight of the hydrated carbon material powder.

6. The hydrated carbon material powder of any one of claims 1-3, wherein the hydrated carbon material powder has a water content greater than 60% based on total weight of the hydrated carbon material powder.

7. The hydrated carbon material powder of any one of claims 1-6, wherein the volume of water ranges from about 10% to 90% greater than the pore volume.

8. The hydrated carbon material powder of any one of claims 1-7, wherein the volume of water ranges from about 10% to 75% greater than the pore volume.

9. The hydrated carbon material powder of any one of claims 1-8, wherein the volume of water ranges from 10% to 50% greater than the pore volume.

10. The hydrated carbon material powder of any one of claims 1-9, wherein the volume of water ranges from about 35% to 45% greater than the pore volume.

11. The hydrated carbon material powder of any one of claims 1-10, wherein the volume of water is about 40% greater than the pore volume.

12. The hydrated carbon material powder of any one of claims 1-8, wherein the volume of water ranges from about 50% to 60% greater than the pore volume.

13. The hydrated carbon material powder of claim 12, wherein the volume of water is about 55% greater than the pore volume.

14. The hydrated carbon material powder of any one of claims 1-8, wherein the volume of water ranges from about 65% to 75% greater than the pore volume.

15. The hydrated carbon material powder of claim 14, wherein the volume of water is about 70% greater than the pore volume.

16. The hydrated carbon material powder of any one of claims 1-9, wherein the volume of water ranges from 20% to 30% greater than the pore volume.

17. The hydrated carbon material powder of any one of claims 1-9, wherein the volume of water ranges from 40% to 50% greater than the pore volume.

18. The hydrated carbon material powder of any one of claims 1-17, wherein the volume of water is at least 20% greater than the pore volume.

19. The hydrated carbon material powder of any one of claims 1-10, wherein the volume of water is at least 40% greater than the pore volume.

20. The hydrated carbon material powder of any one of claims 1-8, wherein the volume of water is at least 60% greater than the pore volume.

21. The hydrated carbon material powder of any one of claims 1-20, wherein the pore volume comprises pores having diameters ranging from greater than 0 nm to 50 nm.

22. The hydrated carbon material powder of any one of claims 1-21, wherein greater than 50% of the pore volume resides in pores having diameters from 2 nm to 50 nm.

23. The hydrated carbon material powder of any one of claims 1-21, wherein greater than 50% of the pore volume resides in pores having diameters greater than 0 nm to less than 2 nm.

24. The hydrated carbon material powder of any one of claims 1-23, wherein about 40% to about 60% of the total pore volume resides in micropores and about 40% to about 60% of the total pore volume resides in mesopores.

25. The hydrated carbon material powder of any one of claims 1-8, wherein the excess water factor ranges from about 1.60 to about 1.80.

26. The hydrated carbon material powder of claim 25, wherein the excess water factor is about 1.7.

27. The hydrated carbon material powder of any one of claims 1-8, wherein the excess water factor ranges from about 1.45 to about 1.65.

28. The hydrated carbon material powder of claim 27, wherein the excess water factor is about 1.55.

29. The hydrated carbon material powder of any one of claims 1-8, wherein the excess water factor ranges from about 1.29 to about 1.49.

30. The hydrated carbon material powder of claim 29, wherein the excess water factor is about 1.39.

31. The hydrated carbon material powder of any one of claims 1-30, wherein the pore volume ranges from 0.3 cc/g to 1.5 cc/g based on weight of the porous carbon material in the absence of the water.

32. The hydrated carbon material powder of claim 31, wherein the pore volume ranges from 0.3 cc/g to 0.8 cc/g based on weight of the porous carbon material in the absence of the water.

33. The hydrated carbon material powder of claim 31, wherein the pore volume ranges from 0.3 cc/g to 0.7 cc/g based on weight of the porous carbon material in the absence of the water.

34. The hydrated carbon material powder of claim 31, wherein the pore volume ranges from 1.0 cc/g to 1.5 cc/g based on weight of the porous carbon material in the absence of the water.

35. The hydrated carbon material powder of any one of claims 1-31, wherein the pore volume is greater than 0.5 cc/g based on weight of the porous carbon material in the absence of the water.

36. The hydrated carbon material powder of any one of claims 1-31, wherein the pore volume is greater than 1.0 cc/g based on weight of the porous carbon material in the absence of the water.

37. The hydrated carbon material powder of any one of claims 1-36, wherein the porous carbon material comprises a total impurity content of less than 500 ppm of elements having atomic numbers ranging from 11 to 92 as measured by proton induced x-ray emission.

38. The hydrated carbon material powder of any one of claims 1-36, wherein the porous carbon material comprises a total impurity content of less than 100 ppm of elements having atomic numbers ranging from 11 to 92 as measured by proton induced x-ray emission.

39. The hydrated carbon material powder of any one of claims 1-38, wherein the porous carbon material has a BET specific surface area ranging from 500 m²/g to 3,000 m²/g.

40. The hydrated carbon material powder of claim 39, wherein the porous carbon material has a BET specific surface area ranging from 500 m²/g to 1,000 m²/g.

41. The hydrated carbon material powder of claim 39, wherein the porous carbon material has a BET specific surface area ranging from 1,000 m²/g to 2,000 m²/g.

42. The hydrated carbon material powder of any one of claims 1-39, wherein the carbon material powder has a BET specific surface area greater than 500 m²/g.

43. The hydrated carbon material powder of any one of claims 1-39, wherein the carbon material powder has a BET specific surface area greater than 1,500 m²/g.

44. The hydrated carbon material powder of any one of claims 1-43, wherein the carbon material powder has a D(50) particle size of about 2 to about 12 microns.

45. The hydrated carbon material powder of any one of claims 1-43, wherein the carbon material powder has a D(50) particle size of about 10 to about 100 microns.

46. The hydrated carbon material powder of any one of claims 1-43, wherein the carbon material powder has a D(50) particle size of about 25 to about 100 microns.

47. The hydrated carbon material powder of any one of claims 1-43, wherein the carbon material powder has a D(50) particle size of about 20 to about 80 microns.

48. The hydrated carbon material powder of any one of claims 1-43, wherein the carbon material powder has a D(50) particle size of about 50 to about 100 microns.

49. An isolated solid composition comprising a porous carbon material and water, wherein the composition comprises a volume of water greater than a total pore volume of the porous carbon material.

50. The isolated solid composition of claim 49, wherein the volume of water ranges from 10% to 90% greater than the total pore volume.

51. The isolated solid composition of any one of claims 49-50, wherein the volume of water ranges from 10% to 75% greater than the total pore volume.

52. The isolated solid composition of claim any one of claims 49-51, wherein the volume of water ranges from 10% to 50% greater than the total pore volume.

53. The isolated solid composition of any one of claims 49-52, wherein the total pore volume ranges from 0.3 cc/g to 1.5 cc/g based on weight of the porous carbon material in the absence of the water.

54. A hydrated carbon material powder consisting of:
a porous carbon material having a pore volume; and
a volume of water greater than the pore volume.

55. A method for preparing a hydrated carbon material powder, the method comprising:
contacting a porous carbon material having a pore volume with a first volume of water greater than the pore volume, thereby substantially filling the pore volume with water;
removing a portion of the first volume of water; and
isolating the hydrated carbon material in powder form,
wherein the hydrated carbon material powder comprises a second volume of water greater than the pore volume.

56. The method of claim 55, wherein the hydrated carbon material powder is as defined in any one of claims 2-54.

57. A method for preparing a negative active material for a lead acid battery, the method comprising admixing the hydrated carbon material powder of any one of claim 1-48 or 54, or the isolated solid composition of any one of claims 49-53, with lead, water and sulfuric acid, thereby forming a paste.

58. Use of the hydrated carbon material powder of any one of claim 1-48 or 54, or the isolated solid composition of any one of claims 49-53, for preparation of an electrode for an electrical storage device.

59. The use of claim 58, wherein the electrical energy storage device is a battery.

60. The use of claim 59, wherein the battery is a lead acid battery.

61. The use of claim 57, wherein the electrical energy storage device is an electric double layer capacitor (EDLC) device comprising:
a. a positive electrode and a negative electrode, wherein each of the positive and negative electrode comprise the hydrated carbon;
b. an inert porous separator; and
c. an electrolyte;
wherein the positive electrode and the negative electrode are separated by the inert porous separator.
